(19) United States
(12) Patent Application Publication
(10) Pub. No.: US 2018/0011244 A1
(43) Pub. Date: Jan. 11, 2018

(54) GENERATION OF ARBITRARY OPTICAL FILTERING FUNCTION USING COMPLEX BRAGG GRATINGS

(71) Applicant: University of Maryland, College Park, MD (US)

(72) Inventors: Tiecheng Zhu, Hyattsville, MD (US); Mario Dagenais, Chevy Chase, MD (US); Sylvain Veilleux, Chevy Chase, MD (US)

(73) Assignee: University of Maryland, College Park, MD (US)

(21) Appl. No.: 15/646,958

(22) Filed: Jul. 11, 2017

Related U.S. Application Data
(60) Provisional application No. 62/360,811, filed on Jul. 11, 2016.
(60) Provisional application No. 62/360,814, filed on Jul. 11, 2016.
(60) Provisional application No. 62/530,441, filed on Jul. 10, 2017.

(51) Int. Cl. G02B 6/02

(52) U.S. Cl. CPC G02B 6/02123; G02B 6/02085; G02B 2006/02166

(57) ABSTRACT

A waveguide Bragg grating includes a silicon substrate defining a length, a width and a depth and a silicon dioxide (SiO₂) cladding over the silicon substrate and encasing a silicon nitride (Si₃Ni₄) core extending along the length of the silicon substrate and defining a variable width and thickness; wherein the silicon nitride (Si₃Ni₄) core is configured as and functions as a complex Bragg grating waveguide. The waveguide Bragg grating is designed by determining a grating profile of the silicon nitride (Si₃Ni₄) core from a Layer Peeling algorithm and a Layer Adding algorithm; and mapping the grating profile to a 1-layer waveguide structure with varying width dimensions. The method further relates the grating profile to an effective index variation and maps the range of the effective index variation to the structure. The width corresponds to a single specific effective index. A method of manufacturing is also disclosed.

### CROSS-REFERENCE TO RELATED APPLICATIONS

This application claims the benefit of, and priority to, U.S. Provisional Patent Application No. 62/360,811 filed on Jul. 11, 2016, entitled “Generation of Arbitrary Optical Filtering Function Using Complex Bragg Gratings”, by Tiecheng Zhu et al., U.S. Provisional Patent Application No. 62/360,814 filed on Jul. 11, 2016, entitled “High Coupling Efficiency Between a Single Mode Optical Fiber and an On-Chip Planar Single Mode Optical Waveguide:” by Tiecheng Zhu et al., and U.S. Provisional Patent Application No. 62/530,441 filed on Jul. 10, 2017, entitled “Layer Peeling/Adding Algorithm and Complex Waveguide Bragg Grating For Any Spectrum Regeneration and Fiber-to-Waveguide Coupler with Ultra-High Coupling Efficiency”, by Tiecheng Zhu, the entire contents of each of which are incorporated by reference herein.

### BACKGROUND

### 1. Technical Field

The present disclosure relates to waveguide Bragg gratings and more particularly to waveguide Bragg gratings designed by a Layer Peeling/Layer Adding Algorithm.

### 2. Discussion of Related Art

One of the simplest optical filters is a Fiber Bragg Grating (FBG) which is basically a special optical fiber with periodic index variation in its fiber core region. Periodic index variation is generally effected with photo-sensitive fibers, excimer lasers and phase-masks. When light passes through the FBG with periodic index variation, one particular wavelength band will be blocked and reflected, while all the other wavelengths will not be affected and will be transmitted. The central reflected wavelength λB, which is called Bragg wavelength, can be calculated using the following phase-matching equation:

λB=2nₑΛ (1.1)

Here, nₑ is the effective index of the FBG, and Λ is the period for the index variation. Wavelength satisfying the above equation will satisfy constructive interference for reflection. Thus this wavelength will be reflected by the Bragg grating. The degree of reflection and the 3-dB bandwidth of the reflection band, will depend on the number of periods and the amount of effective index variation. The simple FBG reflects only one wavelength and permits all other wavelengths to pass through.

Waveguide Bragg Grating (WBG) is the counterpart of FBG on a planar platform. Compared with FBGs which have the benefits of ultra-low propagation loss and perfect polarization independence, the major advantage of WBGs is their compactness and thus the capabilities of integration with other devices.

There is a common limitation for both FBG and WBG: they can remove just one single wavelength band in the transmission spectrum. For most practical applications, the removal of that particular spectral band may be already sufficient. However, there are still some applications which require the removal of more than just one single wavelength.

### SUMMARY

The embodiments of the present disclosure provide significant and non-obvious advantages over the prior art by providing a waveguide Bragg grating that is configured as and functions as a complex waveguide Bragg grating that outputs a reconstructed complex optical spectrum from a target input complex optical spectrum.

More particularly, the present disclosure relates to a waveguide Bragg grating that includes a silicon substrate defining a length, a width and a depth, and a silicon dioxide (SiO₂) cladding over the silicon substrate and encasing a silicon nitride (Si₃Ni₄) core extending along the length of the silicon substrate and defining a variable width and thickness wherein the silicon nitride (Si₃Ni₄) core is configured as and functions as a complex Bragg grating waveguide,

In an aspect of the present disclosure, the thickness of the silicon nitride (Si₃Ni₄) core ranges from 40-400 nm.

In an aspect of the present disclosure, the thickness of the silicon nitride (Si₃Ni₄) core is 100 microns (μm).

In an aspect of the present disclosure, the waveguide Bragg grating is designed by: determining a grating profile of the silicon nitride (Si₃Ni₄) core from a Layer Peeling algorithm and a Layer Adding algorithm; and mapping the grating profile to a 1-layer waveguide structure with varying width dimensions.

In a still further aspect of the present disclosure, the waveguide Bragg grating is further designed by: relating the grating profile to an effective index variation defining a range along the grating and mapping the range of the effective index variation to the 1-layer waveguide structure with varying width dimensions, such that a single specific waveguide width corresponds to a single specific effective index, thereby converting output of the Layer Peeling algorithm and the Layer Addition algorithm to an aperiodic array of widths for the complex waveguide.

In a yet further aspect of the present disclosure, the waveguide Bragg grating is designed by: discretizing the waveguide grating into individual rectangular segments each defining a fixed width and a variable length such that the number of waveguide segments equals to a number of segments in the aperiodic array of widths for the complex waveguide.

In another aspect of the present disclosure, the waveguide Bragg grating is further prepared for electron beam lithography via simulating the aperiodic array of widths via finite difference method (FDM) and eigen mode expansion (EME).

In a still further aspect of the present disclosure, the simulating the aperiodic array of widths via finite difference method (FDM) and eigen mode expansion (EME) includes simulating a three-dimensional array of widths via finite difference method (FDM) and eigen mode expansion (EME).

The present disclosure relates also to a method of designing a waveguide Bragg grating by: waveguide Bragg grating is designed by: determining a grating profile of the silicon nitride (Si₃Ni₄) core from a Layer Peeling algorithm and a Layer Adding algorithm; and mapping the grating profile to a 1-layer waveguide structure with varying width dimensions.

In a still further aspect of the present disclosure, the waveguide Bragg grating is further designed by: relating the grating profile to an effective index variation defining a range along the grating and mapping the range of the effective index variation to the 1-layer waveguide structure with varying width dimensions, such that a single specific waveguide width corresponds to a single specific effective index, thereby converting output of the Layer Peeling algorithm and the Layer Addition algorithm to an aperiodic array of widths for the complex waveguide.

In a yet further aspect of the present disclosure, the waveguide Bragg grating is designed by: discretizing the waveguide grating into individual rectangular segments each defining a fixed width and a variable length such that the number of waveguide segments equals to a number of segments in the aperiodic array of widths for the complex waveguide.

In another aspect of the present disclosure, the waveguide Bragg grating is further prepared for electron beam lithography via simulating the aperiodic array of widths via finite difference method (FDM) and eigen mode expansion (EME).

In a still further aspect of the present disclosure, the simulating the aperiodic array of widths via finite difference method (FDM) and eigen mode expansion (EME) includes simulating a three-dimensional array of widths via finite difference method (FDM) and eigen mode expansion (EME).

The present disclosure relates also to a method of manufacturing a waveguide Bragg grating that includes providing a silicon wafer thermal SiO2 layer grown on a first surface of the silicon wafer; depositing via using low-pressure chemical vapor deposition (LPCVD) a Si3N4 layer on the thermal SiO2 layer; patterning a profile of the waveguide Bragg grating via electron beam lithography; providing a hard mask on the Si3N4 layer; performing reactive ion etching of the Si3N4 layer where it is not protected by a mask and removing the hard mask; depositing a low-stress SiO2 layer on top of the wafer via one of a silane based plasma-enhanced chemical vapor deposition of SiO2 or a low-stress tetraethoxysilane (TEOS) plasma-enhanced chemical vapor deposition (PECVD) process; and cleaving end-facets to form thereby a complex waveguide Bragg grating.

In another aspect of the present disclosure, the method of manufacturing further includes polishing a second surface of the silicon wafer wherein the second surface is on an opposing side of the first surface of the silicon wafer prior to cleaving end-facets to form thereby a complex waveguide Bragg grating.

In an aspect of the present disclosure, the patterning of a profile of the waveguide Bragg grating via electron beam lithography includes controlling writefield alignment of the profile; and overlapping neighboring writefields with each other to control stitching error.

In an aspect of the present disclosure, the providing a silicon wafer with a thermal SiO2 layer grown on a first surface of the silicon wafer includes providing a silicon wafer with a 3-15 μm thermal SiO2 layer grown on a first surface of the silicon wafer.

In an aspect of the present disclosure, the depositing via using low-pressure chemical vapor deposition (LPCVD) a Si3N4 layer on the thermal SiO2 layer includes depositing via using low-pressure chemical vapor deposition (LPCVD) a 100 nm thick Si3N4 layer on the 3-15 μm thermal SiO2 layer.

In an aspect of the present disclosure, the providing a hard mask on the Si3N4 layer, performing reactive ion etching of the Si3N4 layer and removing the hard mask are performed by providing a chromium hard mask on the Si3N4 layer, performing reactive ion etching of the Si3N4 layer and removing the chromium hard mask.

In another aspect of the present disclosure, the depositing a low-stress SiO2 layer on top of the wafer via one of a silane based plasma-enhanced chemical vapor deposition of SiO2 or a low-stress tetraethoxysilane (TEOS) plasma-enhanced chemical vapor deposition (PECVD) process includes depositing a 3-15 μm low-stress SiO2 layer on top of the wafer via one of a silane based plasma-enhanced chemical vapor deposition of SiO2 or a low-stress tetraethoxysilane (TEOS) plasma-enhanced chemical vapor deposition (PECVD) process;

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The above-mentioned advantages and other advantages will become more apparent from the following detailed description of the various exemplary embodiments of the present disclosure with reference to the drawings wherein:

FIG. 1.1A illustrates how a simple fiber Bragg grating according to the prior art reflects only one wavelength and permits all other wavelengths to pass through;

FIG. 1.1B illustrates the various core refractive indices n₀, n₁, n₂ . . . ;

FIG. 1.1C illustrates the spectral response P versus wavelength λ for the input (left portion), the transmitted wavelength (center portion) and the reflected wavelength λ_{B} (right portion);

FIG. 1.2 is an example of an optical fiber application which requires the removal of multiple randomly-distributed wavelengths;

FIG. 1.3 illustrate light input plotted as “Normalized Light Intensity” versus “Wavelength” being transmitted via arrow to an optical filter (black box) which then transmits via another arrow to the light output (for a special shape) which is the target spectrum having an irregular shape, such as a triangle, a rectangle and an arc;

FIG. 1.4A illustrates an example where such arbitrary on-chip optical filters could be of great use wherein when Earth-based telescopes collect light from celestial objects, the collected light contains not only useful spectral information from these objects, but also foreground light emitted by the Earth's own atmosphere;

FIG. 1.4B illustrates a night sky spectrum dominated by hundreds of randomly-distributed OH emission lines, whose absolute and relative intensities are highly time-variable wherein in the astrophysics experiment, these narrow and highly time-variable OH-lines (of order 400 lines) of spectral width of 0.3-0.4 nm have to be removed simultaneously with a large suppression ratio of at least 15 dB;

FIG. 1.5 illustrates a single layer structure of a complex waveguide Bragg grating on aSi₃N₄/SiO₂ waveguide platform according to embodiments of the present disclosure wherein the width of the complex waveguide Bragg grating varies in an aperiodic way;

FIG. 2.1 illustrates application of a layer peeling (LP)/layer adding (LA) In LP/LA algorithm according to embodiments of the present disclosure wherein the overall grating is discretized into many small segments, each with a length of Δ and wherein the total length of the grating is L=NΔ, wherein the effective indices for all these segments can be calculated precisely one by one and a reconstructed spectrum can then be checked;

FIG. 2.2A illustrates the initial step in synthesis of a grating with a special spectrum. wherein a target transmission spectrum has a profile with a rectangle, a triangle and an arc;

FIG. 2.2B illustrates the effective index variation calculated using the Layer Peeling algorithm;

FIG. 2.2C illustrates the reconstructed spectrum obtained from the calculated effective index such that there is a similarity between the target spectrum in FIG. 2.2A and the reconstructed spectrum of FIG. 2.2C;

FIG. 2.3A, illustrate the synthesis of a grating whose transmission spectrum (in dB) has 150 randomly-distributed notches between 1500 nm and 1600 nm, while each notch has its own specific suppression ratio wherein the target transmission spectrum has 150 notches;

FIG. 2.3B illustrates the effective index variation nₑ calculated using the Layer Peeling algorithm;

FIG. 2.3C illustrates the reconstructed spectrum obtained from the calculated effective index in FIG. 2.3B.

FIG. 3.1A illustrates the theoretically expected effective index of the Si₃N₄/SiO₂ waveguide as the width and the thickness of the waveguide core vary wherein the core width of the Si₃N₄/SiO₂waveguide varies but its core thickness is kept constant as 50 nm;

FIG. 3.1B illustrates the theoretically expected effective index wherein the core width of the Si₃N₄/SiO₂ waveguide varies but its core thickness is kept constant as 100 nm;

FIG. 3.1C illustrates the theoretically expected effective index wherein the core width of the Si₃N₄/SiO₂ waveguide varies but its core thickness is kept constant as 200 nm;

FIG. 3.1D illustrates the theoretically expected effective index wherein the core width of the Si₃N₄/SiO₂ waveguide varies but its core thickness is kept constant as 300 nm.

FIG. 3.2 illustrates an optical simulation using FIMMWAVE/FIMMPROP: calculating the mode profile parameters and mapping the effective index to a real waveguide shape;

FIG. 3.3A illustrates assembling and 3D simulation of a complex waveguide Bragg grating according to embodiments of the present disclosure utilizing FIMMWAVE/FIMMPROP with the assistance of Matlab scripts wherein the width/profile of the CWBG is highly aperiodic for a random spectrum;

FIG. 3.3B illustrates that the profile can be exported to e-beam lithography directly

FIG. 3.3C illustrates that spectral notches occur at their prescribed positions in the spectrum;

FIG. 3.4A illustrates the method of designing the complex waveguide Bragg grating according to embodiments of the present disclosure;

FIG. 3.4B is a continuation of the method of designing the complex waveguide Bragg grating of FIG. 3.4A;

FIG. 3.4C is a continuation of the method of designing the complex waveguide Bragg grating of FIGS. 3.4B and 3.4C;

FIG. 4.1 illustrates the fabrication procedures of the Si₃N₄/SiO₂ waveguide coupler with waveguide core thickness of 100 nm;

FIG. 4.2 illustrates settings/adjustments about focus, stigma and aperture are important for a successful EBL pattern;

FIG. 4.3A illustrates that active focus-adjustment is very beneficial for large patterns wherein FIG. 4.3A illustrates that for small pattern within only one writefield, the beam is always well focused;

FIG. 4.3B illustrates that for large patterns, the beam will only be perfectly focused in one writefield and that at other writefields, the beam will be out of focus.

FIG. 4.4A illustrates automatic calculation of the working height distance is performed by a controller of a laser beam;

FIG. 4.4B illustrates the frequency of scanning one pixel, the time required for one scan of CCD-line, and the integration line for one pixel under automatic pixel control on a computer display for the laser height sensing (LHS) operation of FIG. 4.3A;

FIG. 4.5 demonstrates stitching errors between two neighboring writefields (WF), caused during improper setting/alignment in the e-beam lithography;

FIG. 4.6A illustrates SEM figures of a real 47-notch grating of the joint section between two Δ segments which have different complex coupling efficiencies q(z);

FIG. 4.6B illustrates a section within one Δ segment;

FIG. 4.7 illustrates an experimental set-up for the waveguide performance measurement, showing two XYZ stages which hold input and output fibers, two microscope cameras for fiber/waveguide alignment and a waveguide sample mounted in the middle;

FIG. 4.7A illustrates that the design of a specific CWBG device starts with a target transmission spectrum with an arbitrary shape;

FIG. 4.7B illustrates that the effective index profile is calculated/examined using an LP/LA algorithm;

FIG. 4.7C illustrates that the effective index is mapped to the actual width profile of the CWBG;

FIG. 4.7D illustrates a single-layer CWBG device implemented on a silica-on-silicon platform wherein the width is continuously varying in the y-direction, while the thickness remains the same and light propagates along the z-direction;

FIG. 4.7E illustrates an SEM picture showing a portion of the actual CWBG with continuously varying width;

FIG. 4.7F illustrates that performance of the CWBG device is characterized experimentally;

FIG. 4.8 shows both the simulation results (light color plots) and the experimental transmission spectrum results (dark color plots) for the CWBG device which removes 20 randomly distributed narrow spectral lines between 1530 nm and 1560 nm simultaneously;

FIG. 4.9 illustrates the effective index variation along the grating whose spectrum is shown in FIG. 4.8 wherein the effective index is calculated from the Layer Peeling algorithm, and is varying in an aperiodic way;

FIG. 4.10 illustrates the experimental transmission spectrum of a fabricated CWBG device, showing the removal of 47 prescribed narrow spectral lines simultaneously;

FIG. 4.11 illustrates the effective index variation along the grating whose spectrum is shown in FIG. 4.10 wherein the effective index is calculated from the Layer Peeling algorithm, and is varying in an aperiodic way;

FIG. 5.1A illustrates the originally fabricated CWBG whose spectral notches are not shifted;

FIG. 5.1B illustrates the second CWBG with modified parameters, whose spectral notches are all shifted 10 nm to lower wavelengths;

FIG. 5.2A illustrates an absorption dip occurs before application of a thermal annealing process to the 47-notch grating sample;

FIG. 5.2B illustrates the results of annealing with respect to the absorption dip at a temperature of 1200° C. applied for 0.5 hours;

FIG. 5.2C illustrates that the absorption dip does not occur after 1.5 hours of annealing at 1200° C.; and

FIG. 5.2D illustrates that the absorption dip does not occur after 3.5 hours of annealing at 1200° C.

### DETAILED DESCRIPTION

For the purposes of promoting an understanding of the principles of the present disclosure, reference will now be made to the exemplary embodiments illustrated in the drawings, and specific language will be used to describe the same. It will nevertheless be understood that no limitation of the scope of the present disclosure is thereby intended. Any alterations and further modifications of the inventive features illustrated herein, and any additional applications of the principles of the present disclosure as illustrated herein, which would occur to one skilled in the relevant art and having possession of this disclosure, are to be considered within the scope of the present disclosure.

The word “exemplary” is used herein to mean “serving as an example, instance, or illustration.” Any embodiment described herein as “exemplary” is not necessarily to be construed as preferred or advantageous over other embodiments.

It is to be understood that the method steps described herein need not necessarily be performed in the order as described. Further, words such as “thereafter,” “then,” “next,” etc., are not intended to limit the order of the steps. Such words are simply used to guide the reader through the description of the method steps.

1: Introduction

1.1 Single-Notch Filter vs Multi-Notch Filter

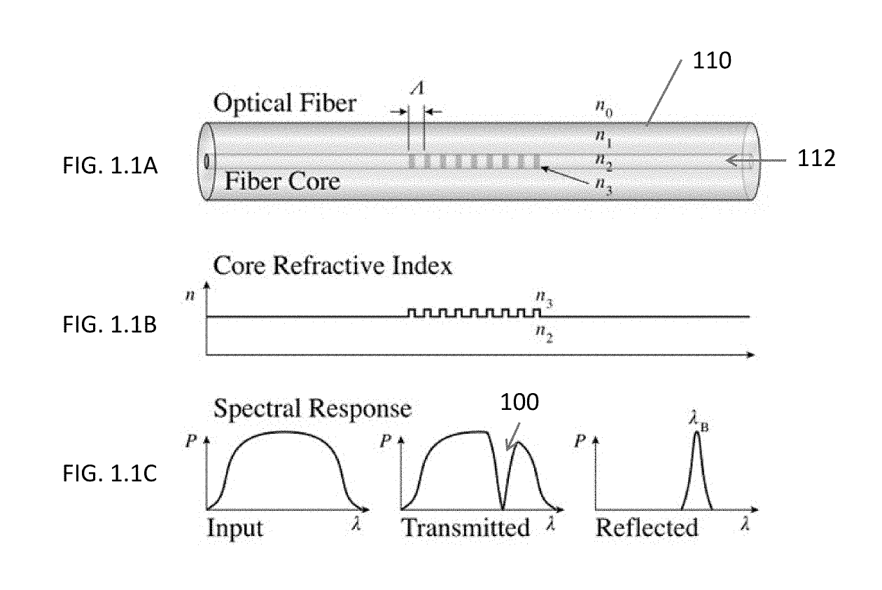

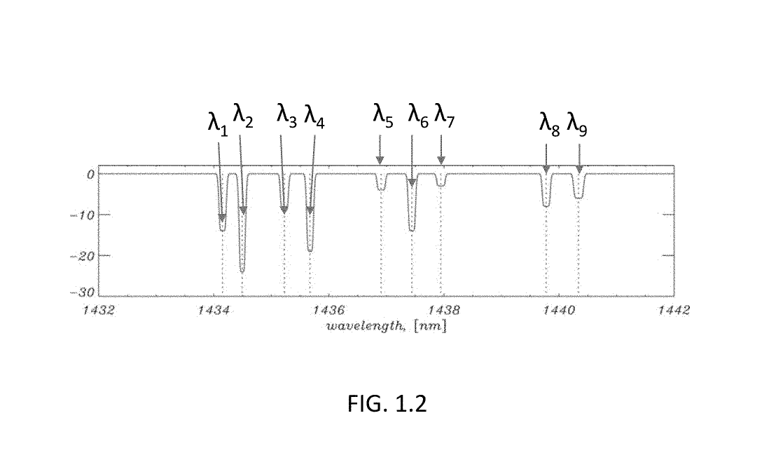

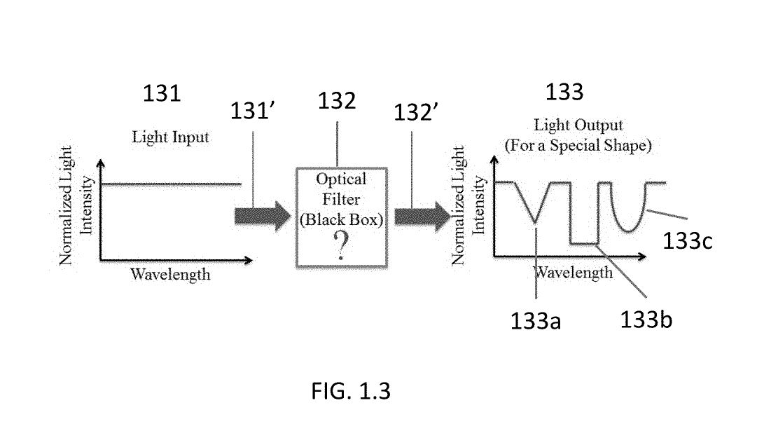

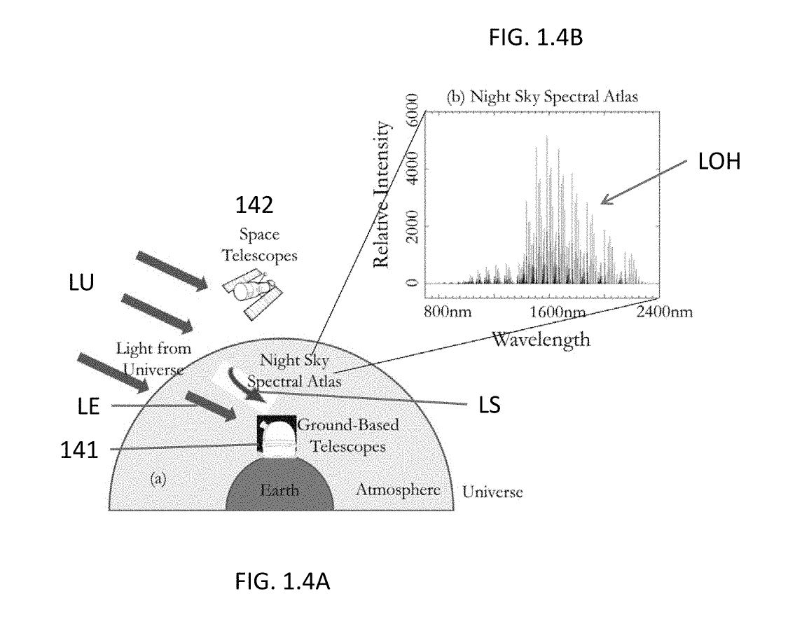

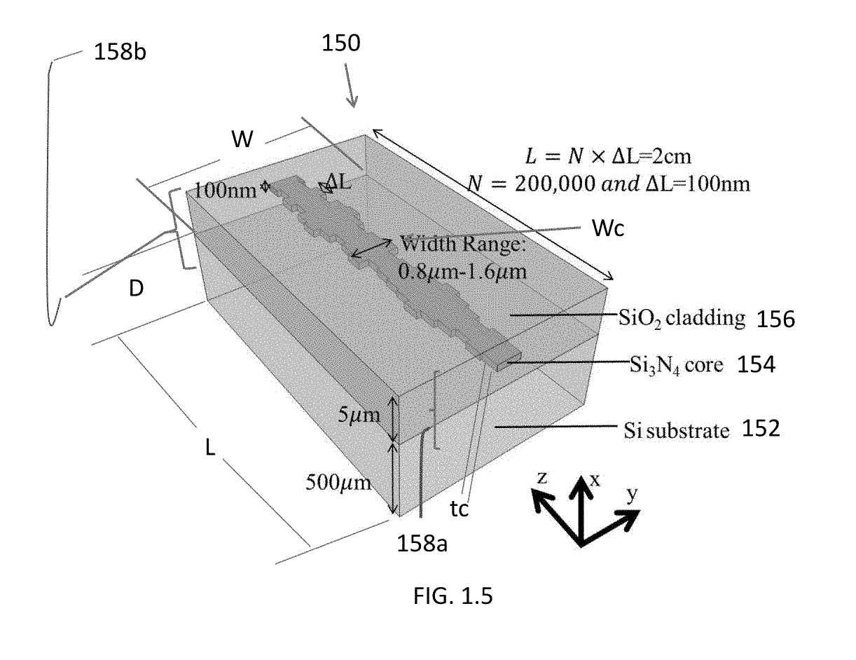

To understand the advantages of the embodiments of the present disclosure, designing and fabricating optical filters is discussed herein It is best to start from one of the simplest optical filters, which is a Fiber Bragg Grating (FBG) [1] [2] [3] [4]. As shown in FIG. 1.1A, a FBG is basically a special optical fiber with periodic index variation in its fiber core region 112. Periodic index variation is generally effected with photo-sensitive fibers, excimer lasers and phase-masks. When light passes through the FBG 110 with periodic index variation, one particular wavelength band will be blocked and reflected, while all the other wavelengths will not be affected and will be transmitted. The central reflected wavelength λ_{B}, which is called Bragg wavelength, can be calculated using the following phase-matching equation:

λ_{B}=2nₑΛ (1.1)

Here, nₑ is the effective index of the FBG, and Λ is the period for the index variation.

Wavelength satisfying the above equation will satisfy constructive interference for reflection. Thus this wavelength will be reflected by the Bragg grating. The degree of reflection and the 3-dB bandwidth of the reflection band, will depend on the number of periods and the amount of effective index variation.

As seen in FIG. 1.1A, the simple FBG 110 reflects only one wavelength and permits all other wavelengths to pass through.

FIG. 1.1B illustrates the various core refractive indices n₀, n₁, n₂ . . . .

FIG. 1.1 C illustrates the spectral response P versus wavelength λ for the input (left portion), the transmitted wavelength (center portion) and the reflected wavelength λ_{B} (right portion). The limitation is that there is only one notch 100 in the transmitted spectrum.

Waveguide Bragg Grating (WBG) is the counterpart of FBG on a planar platform [5] [6] [7]. Compared with FBGs which have the benefits of ultra-low propagation loss and perfect polarization independence, the major advantage of WBGs is their compactness and thus the capabilities of integration with other devices. The complex waveguide and grating devices according to embodiments of the present disclosure can be fabricated on a small chip of only finger nail size. Also, because fibers and integrated waveguides both have its pros and cons (waveguides are lossy but compact, fibers have low loss but take more space), the interaction between them becomes an important and popular topic.

There is a common limitation for both FBG and WBG: they can remove just one single wavelength band in the transmission spectrum. For most practical applications, the removal of that particular spectral band may be already sufficient. However, there are still some applications which require the removal of more than just one single wavelength. For instance, as shown in FIG. 1.2, quite a few wavelengths, e.g., nine λ₁ . . . λ₉ need to be removed simultaneously in the transmission spectrum [8]. In this case, the idea of a simple FBG or WBG is not sufficient. Several main reasons are explained below.

First of all, when some of the target wavelengths to be removed are distributed very closely in the spectral domain, it will be hard to realize these close spectral notches on a physical device. Assume the task is that it is desired to remove both the wavelengths of 1550 nm and 1551 nm with a 3-dB width of only 0.2 nm-0.3 nm.

That means if we are going to use one grating to filter out 1550 nm, and another grating for 1551 nm, assuming an average effective index of 1.500, the periods of these two gratings are

$$\begin{matrix}{Λ}_{1} = \frac{{λ}_{B 1}}{2 {n}_{e}} = 516.67 nm & ( 1.2 ) \\ {Λ}_{2} = \frac{{λ}_{B 2}}{2 {n}_{e}} = 517.00 nm & ( 1.3 )\end{matrix}$$

Setting aside whether a period of 516.67 nm can be written accurately or not, just look at the length difference between two periods of the 1ₛₜ grating and the 2_{nd} grating, which is only 0.33 nm in this example. That is to say, the period of the 2_{nd} grating needs to be only 0.33 nm larger than the period of the 1ₛₜ grating. In real fabrication, it is impossible to fabricate two separate gratings whose periods are just 0.33 nm different.

The second reason why cascading simple FBGs or WBGs is not desirable for multi-notch filtering applications lies in the total size and the overall loss. Connecting all these gratings together will give a long device overall (especially for FBG), and it will result in very low throughput correspondingly (especially for WBG).

Moreover, there are also potential problems of narrow-band filtering and side-lobes. If the bandwidths of the spectral notches need to be very narrow, say only 0.3 nm for the 3-dB width, then a long grating is required with a large number of periods and very small effective index variations.

Finally, if we want to regenerate a very smooth transmission/reflection spectrum without any obvious spectral side-lobes, then the techniques of apodization should be added to the design of gratings, which increases the complexity of the design and fabrication.

1.2 The Fundamental Problem of Optical Filter Design

It is useful at this point to consider some fundamental and general theory suitable for all the various applications, not just notch filters. Although single-notch and multi-notch filters have been discussed, the filtering function itself need not be limited to one single spectral type. Thus one of the fundamental problems for designing optical filters is whether it is possible to realize any arbitrary filtering function. A traditional optical filter, either a FBG or a WBG, removes only one particular spectral band in its transmission spectrum.

In FIG. 1.3, the light input 131 plotted as “Normalized Light Intensity” versus “Wavelength” is transmitted via arrow 131′ to an optical filter (black box) 132 which then transmits via arrow 132′ to the light output (for a special shape) 133 which is the target spectrum having an irregular shape, such as a triangle 133a, a rectangle 133b and an arc 133c. What if the objective is to realize a filter that needs to remove hundreds of spectral bands simultaneously? Are there complex filters available for such general purposes? And if so, then how should the blackbox 132 be constructed both theoretically and experimentally?

1.3 An Important Application in Astrophysics

FIG. 1.4A illustrates an example where such arbitrary on-chip optical filters could be of great use [9, 10]. When Earth-based telescopes 141 collect light LU from celestial objects, the collected light contains not only useful spectral information from these objects, but also foreground light LE emitted by the Earth's own atmosphere. In the near-infrared region, particularly between wavelengths of 1 μm and 1.8 μm, the night sky spectrum is dominated by bright spectral lines LS due to hydroxyl (OH) emission from the atmosphere. As shown in FIG. 1.4B, there are hundreds of randomly-distributed OH emission lines LOH over this wavelength range, and each of these lines is very narrow.

The absolute and relative intensities are highly time-variable wherein in the astrophysics experiment, these narrow and highly time-variable OH-lines (of order 400 lines) of spectral width of 0.3-0.4 nm have to be removed simultaneously with a large suppression ratio of at least 15 dB.

The signal from these lines completely dominates over that of most astronomical targets, particularly faint distant sources whose emission is red-shifted into the near-infrared window due to cosmological expansion. As a result, astrophysicists have long sought to reduce or eliminate altogether the effects of the Earth's atmosphere by having facilities operating at very high altitudes (e.g., Stratospheric Observatory for Infrared Astronomy) or in space (e.g., Hubble Space Telescope). These facilities are, however, much more expensive than ground-based telescopes of the same sizes.

A potentially cheaper solution is to use ground-based telescopes but eliminate the OH emission lines using complex optical filters. At first thought, thin-film optical filters, fabricated using the optical thin-film coating technology [11], may be a good starting point. However, as will be shown later, to realize a complex filter that removes multiple narrow spectral lines, the filter itself has to be constituted of as many as 200,000 segments/layers, whose index variations have no regularity. This makes it unpractical for thin-film filters of as many as 200,000 segments/layers, whose index variations have no regularity. This makes it unpractical for thin-film filters.

It has been shown that the OH emission lines LOH can be filtered out using an aperiodic Bragg grating implemented on a fiber platform [12]. An aperiodic fiber Bragg grating (FBG) with a total length of 5 cm is capable of removing 100 narrow OH emission lines simultaneously. Such aperiodic FBG devices have been tested on ground-based telescopes and delivered promising results [8] [13] [14] [15].

According to embodiments of the present disclosure, an alternative approach is proposed based on Bragg gratings on planar waveguide platforms for applications requiring integration and compactness. In the astrophysics experiment, a large number (of order 400) of narrow OH lines with spectral width of 0.3-0.4 nm and spectral precision better than ±0.1 nm have to be removed simultaneously with a large suppression ratio of at least 15 dB, as they all contribute to a broad and highly time-variable background light level in the spectrometer. Such a background has to be removed in order to study faint objects in the night sky. The present disclosure presents the theoretical and experimental approaches for realizing such a complex waveguide Bragg grating (CWBG). As discussed below, this type of CWBG may find applications not only in the field of astrophysics, but also potentially in the areas of ultra-fast pulse generation [16] [17] and slow-light [18].

1.4 Searching for an Integrated Optical Filter for Any Spectrum

Therefore, the embodiments of the present disclosure relate to designing a single grating which can realize basically any spectral shape. Fortunately, just focusing on the theory and disregarding the difficulty of implementation, there are indeed some very good theoretical models and methods to solve this problem [19] [20]. In general, all these methods are called inverse scattering (IS) algorithms, as they are just the reverse process of finding the spectrum from the effective index profile, which is categorized as forward scattering problems. According to the IS algorithm, one single complex-shaped grating is already enough to remove multiple spectral lines with various depths and bandwidths. The input here is the desired spectral shape, and the output of the theory shows the grating profile or the effective index distribution along the grating. To further comprehend these theories, a comparison between various methods of grating synthesis has been performed in Reference [21].

One objective of the embodiments of the present disclosure is to go from the algorithm to making a real complex grating or complex optical filter.

Such optical filters have already been realized successfully on the fiber platform to remove many spectral lines [12]. However, the size of this aperiodic fiber Bragg gratings (AFBG) is not very compact and the approach does not lead to ease of integration with other integrated photonic devices. Compared with FBG, WBG is implemented on the waveguide platform, and has much smaller footprint and is suitable for dense-integration applications in the future. The fabrication process of WBG is also CMOS-compatible, and thus provides certain advantages, WBG were also written by deep-UV lithography experimentally for random spectral tailoring [22] [23], however the algorithm only assumes low index variation and neglects second-order and higher-order reflections. Moreover, the fabricated WBG is based on a 2-layer waveguide structure, which requires two lithography and two etching steps, giving some difficulty of precise pattern overlap between multiple lithography steps. More lithography steps also indicate larger cost in the fabrication or manufacturing, thus limiting the future potential of mass production and commercialization.

FIG. 1.5 illustrates a physical 3D complex WBG structure 150 according to embodiments of the present disclosure wherein the width of the complex waveguide Bragg grating varies in an aperiodic way. The fabrication process is CMOS-compatible and is easy to implement. The complex waveguide Bragg grating 150 only has one single layer (Si₃N₄ core 154) and the only varying parameter is the width W of the Si₃N₄ core 154 waveguide width.

More particularly, the waveguide Bragg grating 150 includes a silicon substrate 152 defining a length L, a width W and a depth D and a silicon dioxide (SiO₂) cladding 156 over the silicon substrate 152. The silicon dioxide (SiO₂) cladding 156 encases the silicon nitride (Si₃Ni₄) core 154 and extends along the length L of the silicon substrate 152 and defines a variable width Wc and thickness tc. The silicon nitride (Si₃Ni₄) core 154 is configured as and functions as a complex waveguide.

The thickness tc of the silicon nitride (Si₃Ni₄) core 154 may range from from 40-400 nm, depending if the waveguide is weakly or strongly guiding in the vertical X direction.

In one embodiment, the thickness tc of the silicon nitride (Si₃Ni₄) core 154 is 100 microns (μm).

The Si₃N₄/SiO₂ waveguide material system 150 has compact size, low propagation loss, high coupling efficiency and an ultra-broadband transparency window. It is an elegant structure which scales like a small chip.

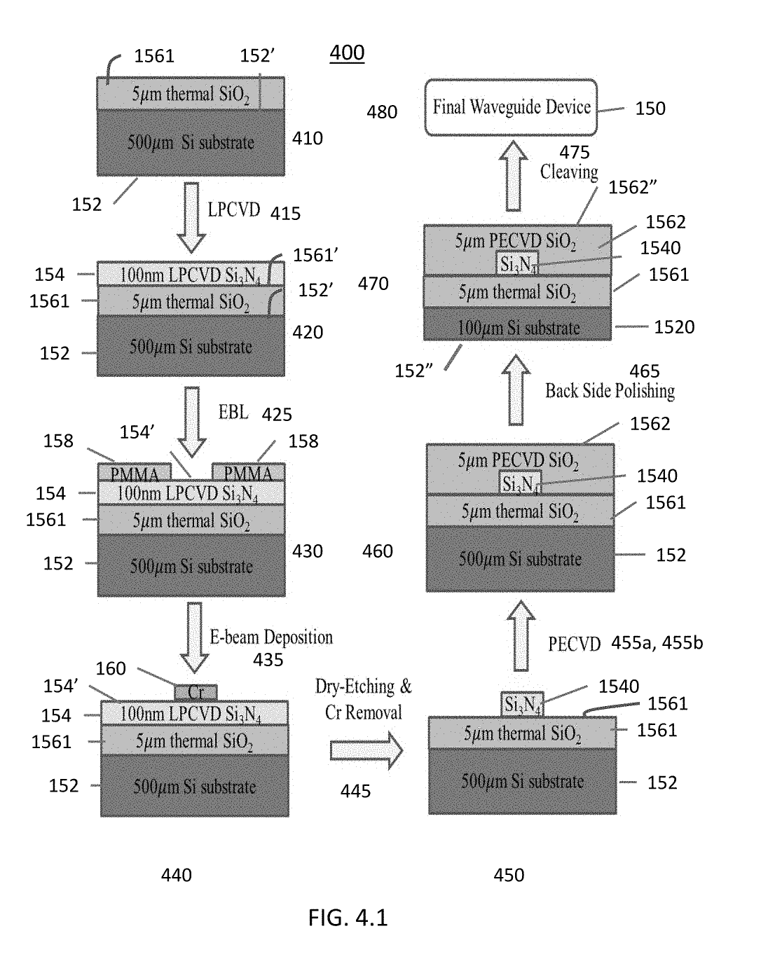

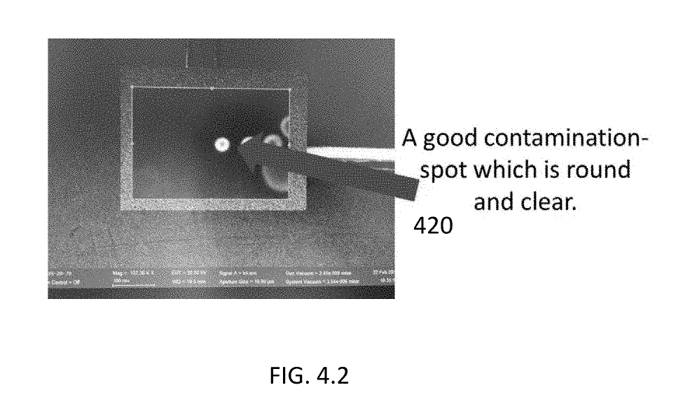

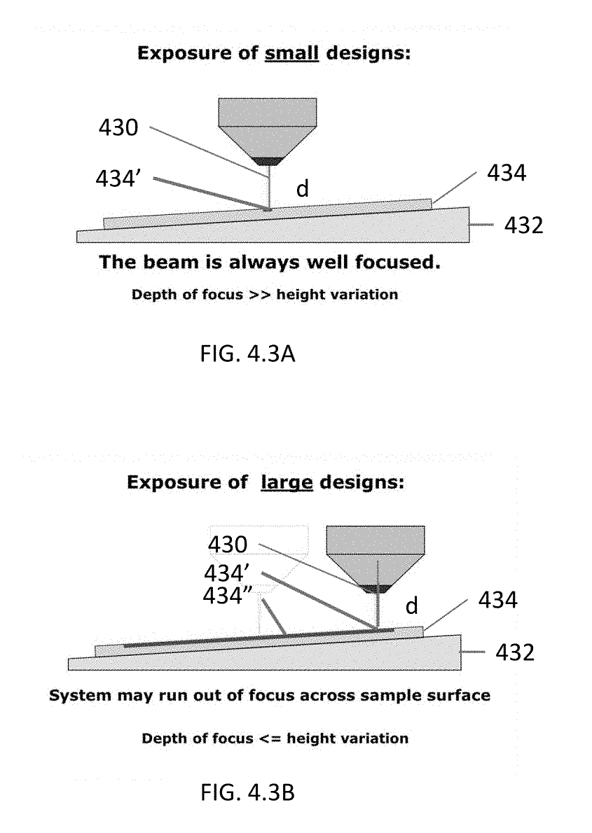

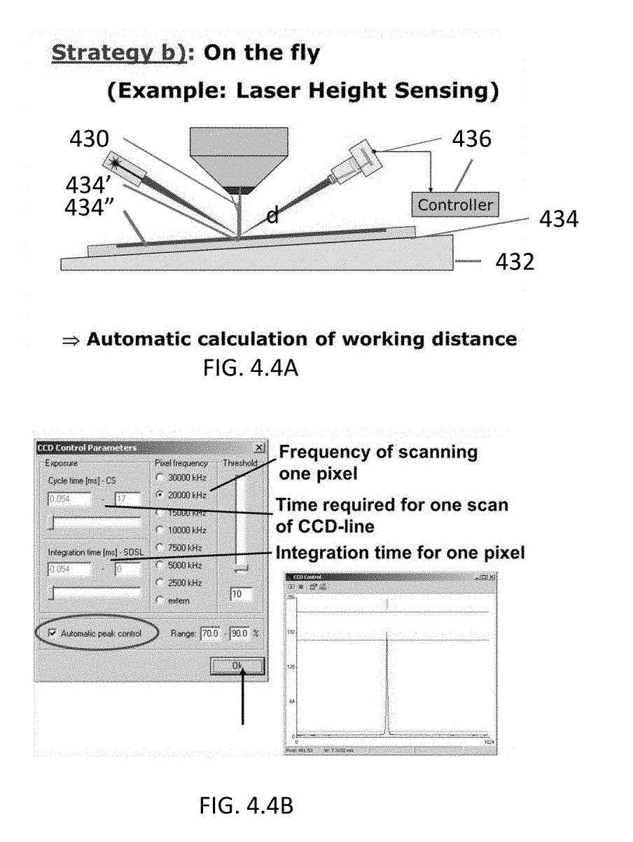

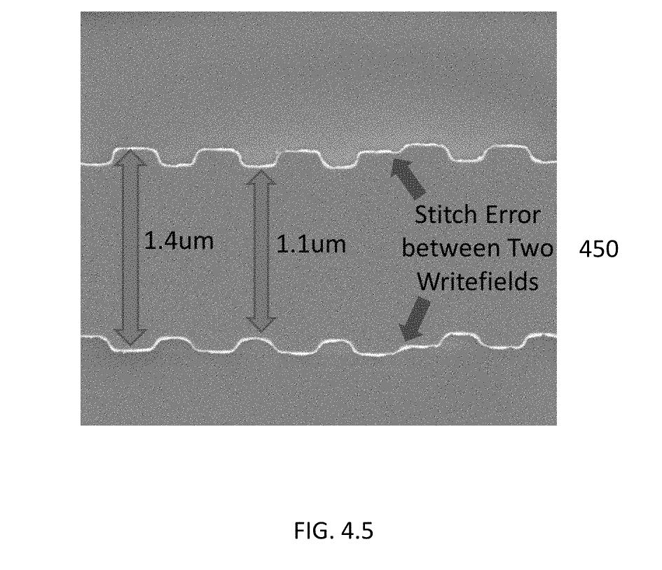

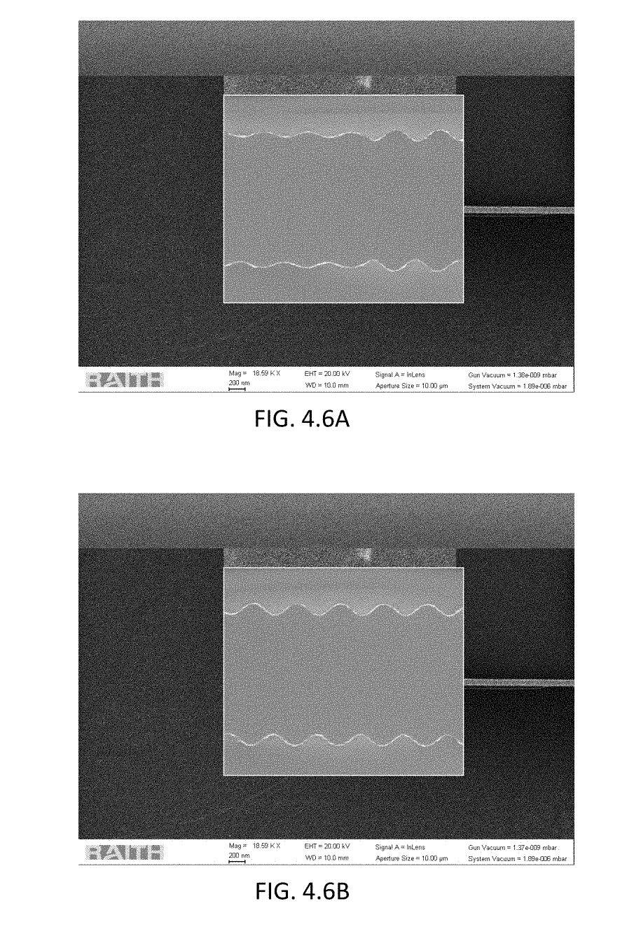

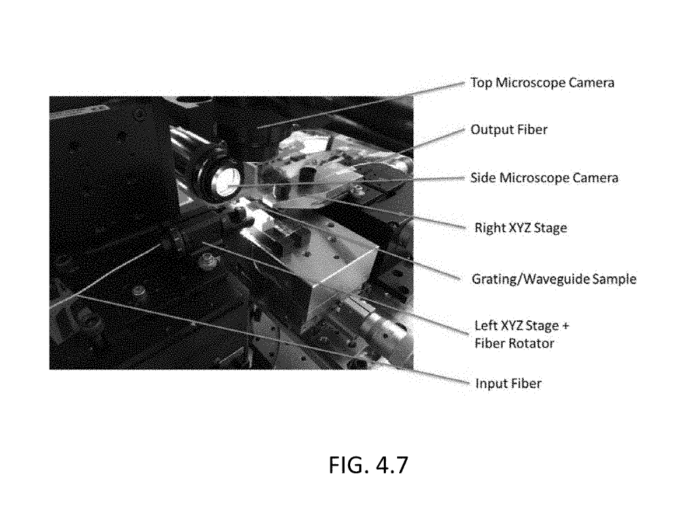

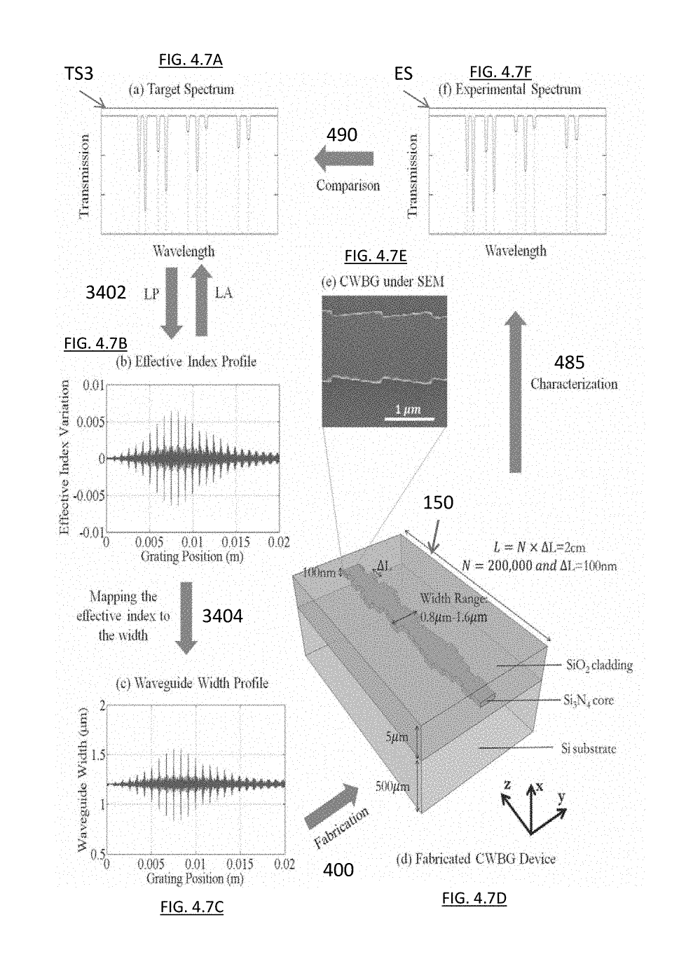

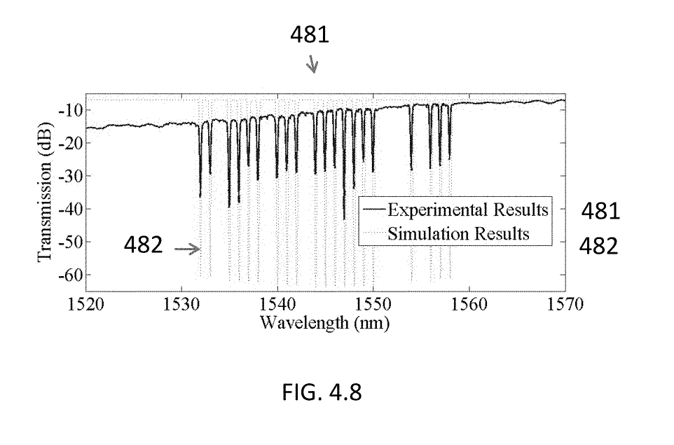

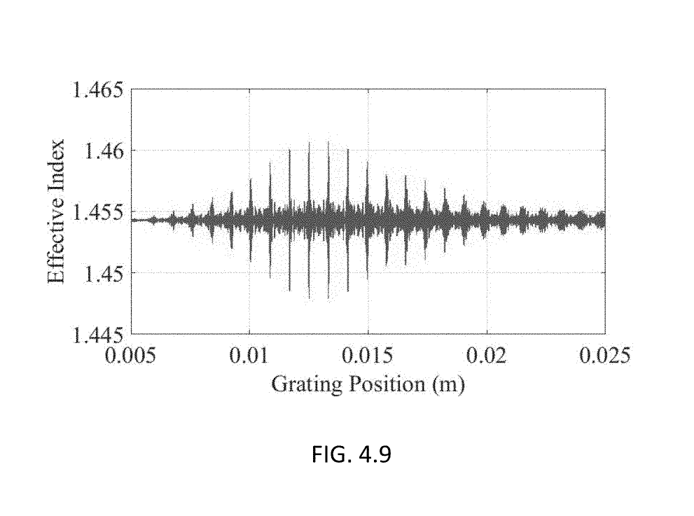

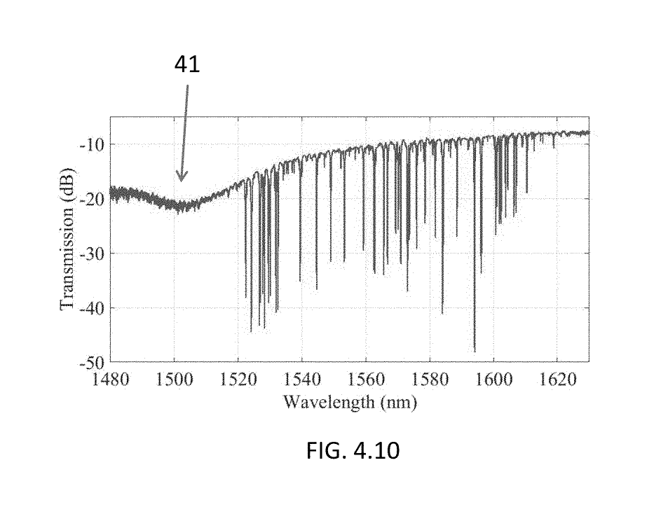

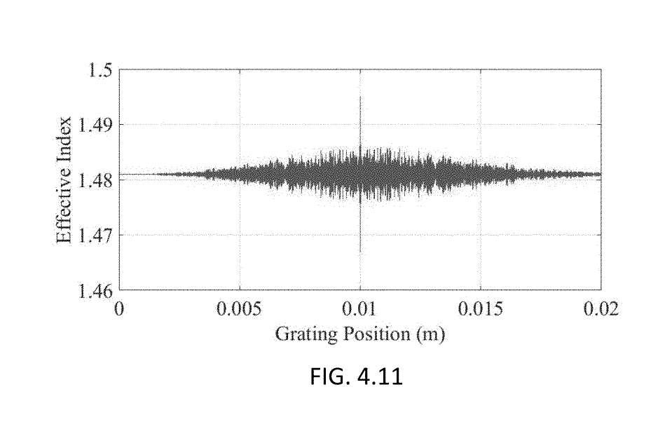

As described below in more detail with respect to FIG. 4.1, referring to FIG. 1.5, the SiO2 layer 156 below and above the Si3N4 layer 154 together have a thickness such that the guided wave does not extend significantly all the way to the Si substrate 152 below (to avoid absorption of light) or to the air layer above the SiO2 layer 156. Typically, the SiO2 layer 156 thickness below and above the Si3N4 layer 154 should be between 2 and 15 um, depending how confined the light is in the guiding waveguide. The weakly guided mode would require a larger thickness of SiO2 and vice versa. The width and thickness of the Si3N4 layer are chosen such that the waveguide supports a single transverse electric (TE) or a single transverse magnetic (TM) mode or both.

2: Layer Peeling & Adding Algorithm

In order to explain the theoretical algorithm for designing the optical filter, some introduction and derivations of the coupled mode theory and the transfer matrix method will be given at first. Then the Layer Peeling/Adding Algorithm will be discussed. Finally, several real filter design examples will be demonstrated to show not only the effectiveness of the algorithm and but also the effective index variations for realizing specific spectra.

2.1 Coupled Mode Theory

Coupled mode theory (CMT) is one of the most successful theories for investigating any type of grating structure. The grating is essentially an optical fiber or waveguide structure with an effective index perturbation. In a medium which has a constant refractive index everywhere, different optical modes are orthogonal to each other in principle. But as long as an effective index perturbation occurs, different modes will start talking to each other. For instance, some optical power of the forward-propagating mode may be transferred to that of the backward-propagating mode, the degree of which depends on the amount of the effective index variation. CMT is presented and described elegantly in a number of papers and books, and some of those references can be found in [24] [25] [26] [27] [28]. It is noted that the scientific notations are slightly different between these references. For simplicity, the notation in the present disclosure follows [24] closely. In this notation, light propagates along only +z (forward) and −z (backward) direction. The x and y are both traverse directions. Also, the implicit time dependence is exp(−iωt), so the forward propagating wave with the propagation constant β will have the form with the term exp[i(βz−ωt)].

To start with, several reasonable assumptions are made here. First of all, in the algorithm it is assumed the waveguide is lossless. In other words, the refractive index is a real number. Secondly, it is assumed that single-mode condition is observed in the entire spectral range, which means no higher order radiating mode occurs. This indicates that only forward-propagating mode and backward-propagating mode should be considered in the theory. It is also the real situation in FBGs and WBGs. Thirdly, the index variation is assumed to be much smaller than the average effective index n0. Let us first recall the four Maxwell's Equations:

$$\vec{∇} \cdot \vec{D} = ρ \\ \vec{∇} \cdot \vec{B} = 0 \\ \vec{∇} \times \vec{E} = - \frac{\partial \vec{B}}{\partial t} \\ \vec{∇} \times \vec{H} = \vec{J} + \frac{\partial \vec{D}}{\partial t} \qquad ( 2.1 )$$

where \vec{E} and \vec{H} are electric and magnetic field vectors, and \vec{D} and \vec{B} are electric and magnetic flux densities, respectively. \vec{J} is the current density and ρ is the free charge density.

To start with, several reasonable assumptions are made here. First of all, in the Then the derivations indicate the following. The scalar wave equation (deduced directly from the above Maxwell's equations assuming ρ=0 and J=0) tells us that

{∇²+k²n²(x, y, z)}Ε(x, y, z)=0 (2.2)

This can be further written as:

{∇ₜ²+k²n²(x, y, z)+δ²/δz²}Ε₂(x, y, z)=0 (2.3)

Here ∇²=δ²/δx²ₜ+δ²/δy², and k=ω/c is the vacuum wavenumber. Here, n is the overall effective index which includes both the average effective index and the effective index variation. As a comparison, we will now define another parameter no to represent the average effective index, which is a constant for the grating.

Since we are considering the coupling between the forward-propagating mode and the backward-propagating mode, the electric field can be written as

Ε(x, y, z)=b₁(z)Ψ(x, y)+b−1(z)Ψ(x, y) (2.4)

The whole electric field Ε(x, y, z) should satisfy (2.3), and Ψ(x, y) should satisfy the wave equation with average index n0 below

{∇ₜ²+k²n₀²−β²}Ψ(x, y)=0 (2.5)

To reach (2.5), it should be remembered that the electric field in a medium with constant index has a propagation term which is either exp(+iβz) or exp(−iβz).

From (2.3) (2.4) (2.5) we can obtain

$$\frac{{d}^{2}}{{dz}^{2}} ( {b}_{1} + {b}_{- 1} ) Ψ + [ {β}^{2} + {k}^{2} ( {n}^{2} - {n}_{0}^{2} ) ] ( {b}_{1} + {b}_{- 1} ) Ψ = 0 \qquad ( 2.6 )$$

Multiplying (2.6) by Ψ and integrating over the whole xy-plane, we can get

$$\frac{{d}^{2}}{{dz}^{2}} ( {b}_{1} + {b}_{- 1} ) + [ {β}^{2} + 2 k {n}_{0} {D}_{11} ( z ) ] ( {b}_{1} + {b}_{- 1} ) = 0 \qquad ( 2.7 )$$

where

D₁₁(z)≈k(n−n0) (2.8)

because n²−n²≈2n0(n−n0), with the third assumption we made before. Now, (2.7) can be decomposed into a set of first order differential equations

$$\begin{matrix}\frac{{db}_{1}}{dz} = i ( β + {D}_{11} ) {b}_{1} + i {D}_{11} {b}_{- 1} & ( 2.9 ) \\ \frac{{db}_{- 1}}{dz} = - i ( β + {D}_{11} ) {b}_{- 1} - i {D}_{11} {b}_{1} & ( 2.10 )\end{matrix}$$

If there is no index variation, n=n0, D11=0, then b1(z) ∝ exp(iβz) and b−1(z) ∝ exp(−iβz). Then b1(z) will have no interaction with b−1(z) at all. On the contrary, if there is an index variation, then D11≠0, so the forward and backward modes will start to interact with each other.

For grating 150, the index variation can be represented as

$$n - {n}_{0} = Δ n ( z ) {cos ( \overline{Λ z} + θ ( z ) )}^{2 π} \qquad ( 2.11 )$$

and D11(z) can be rewritten as

$${D}_{11} ( z ) = κ ( z ) exp ( i \begin{matrix}\underline{2 π} \\ Λ\end{matrix} z ) + {κ}^{*} ( z ) exp ( - i \begin{matrix}\underline{2 π} \\ Λ\end{matrix} z ) \qquad ( 2.12 )$$

where κ(z) is a complex and slowly varying function of z. To further simplify (2.9) and (2.10), the new field amplitude u and v are defined as

$$\begin{matrix}{b}_{1} ( z ) = u ( z ) exp ( i \frac{π}{Λ} z ) & ( 2.13 ) \\ {b}_{- 1} ( z ) = υ ( z ) exp ( - i \frac{π}{Λ} z ) & ( 2.14 )\end{matrix}$$

Using (2.9) (2.10) (2.12) (2.13) (2.14 the coupled mode equations are obtained

$$\begin{matrix}\frac{du}{dz} = i δ u + q ( z ) v & ( 2.15 ) \\ \frac{dv}{dz} = - i δ v + {q}^{*} ( z ) u & ( 2.16 )\end{matrix}$$

where δ=β−π/Λ is the wavenumber detuning with respect to the central wavelength λ0=2n0Λ, and q(z) is the complex coupling coefficient q(z)=iκ(z)

From the Layer Peeling/Adding algorithm that is described in 2.2 below, we can calculate all the values of q(z), but for a physical optical filter, knowing only q(z) is far from satisfactory. To design a real optical filter, it is most important to know the effective index n(z) along that filter. The important relation between q(z) and n(z) is given below:

$$\begin{matrix}\vert q ( z ) \vert = \frac{πΔ n ( z )}{λ} & ( 2.17 ) \\ arg ( q ( z ) ) = θ ( z ) + π / 2 & ( 2.18 )\end{matrix}$$

Now that we know the coupled-mode equations and the relation between q(z) and n(z). The coupled mode equations derived above are a set of elegant and classic equations. They form the basis for the theory that will be used later.

2.2 Transfer Matrix Method

Transfer matrix method (TMM) is the typical method used in the forward-scattering problems, as it calculates the transmission/reflection spectrum starting from the effective indices. It is a simple and straightforward approach shown in many books [27] [28]. On the contrary, the Layer Peeling algorithm, which is deduced below, allows us to calculate the effective index from the final spectrum.

Transfer matrix method uses a discretized model, where it discretizes the whole grating into a sufficient number N of small segments. Each segment is so short that it can be treated as having just a constant effective index variation intensity. In other words, the effective index of each Δ segment will vary sinusoidally according to (3.2) with Δn(z) to be constant. Δn(z) of different Δ segment may not be the same, and in our cases it can be very aperiodic. If the overall length of the grating is L, then the length of each segment will be

Δ=L/N (2.19)

Derived from the coupled mode equations before, the electric fields can be written as

$$[ \begin{matrix}u ( z + Δ ) \\ v ( z + Δ )\end{matrix} ] = [ \begin{matrix}cosh ( γΔ ) + i \frac{δ}{γ} sinh ( γΔ ) & \frac{q}{γ} sinh ( γΔ ) \\ \frac{{q}^{*}}{γ} sinh ( γΔ ) & cosh ( γΔ ) + i \frac{δ}{γ} sinh ( γΔ )\end{matrix} ] \qquad ( 2.20 )$$

Here, light propagates along the z direction, u(z) and v(z) are the forward-propagating and backward-propagating field amplitude at location z, u(z+Δ) and v(z+Δ) are the forward-propagating and backward-propagating field amplitude at location z+Δ. q is the complex coupling coefficient in accordance with the previous section, δ=β−π/Λ is the wavenumber detuning, and γ is defined as γ²=|q|²−δ². (2.20) calculates u(z+Δ) and v(z+Δ) from the information of u(z) and v(z), given the effective index variation in this Δ segment. Note here that the effective index variation is not shown in (2.20) explicitly, and instead it is contained in q.

From the above equation for a single segment, the overall transfer matrix of the grating is

T=T_{N}T_{N}−1T_{N}−2 . . . T₂T₁ (2.21)

### Therefore,

$$[ \begin{matrix}u ( L ) \\ v ( L )\end{matrix} ] = T [ \begin{matrix}u ( 0 ) \\ v ( 0 )\end{matrix} ] = [ \begin{matrix}{T}_{11} & {T}_{12} \\ {T}_{21} & {T}_{22}\end{matrix} ] [ \begin{matrix}u ( 0 ) \\ v ( 0 )\end{matrix} ] \qquad ( 2.22 )$$

Notice that in (2.22), v(L)=0 since the light will only go forward at z=L. The transfer matrix T is also wavelength dependent, and the wavelength information is already contained in the γ and δ parameter. Finally, the reflection coefficient can be obtained from T as

r(δ)=−T₂₁/T₂₂ (2.23)

As a brief conclusion of the transfer matrix method, it should be emphasized that its main purpose is to calculate the transmission/reflection spectrum from the effective indices of the gratings/filters for all the wavelengths. It also means the direction of calculation is from the space domain to the frequency domain. It is considered as a forward-scattering method. 2.3 Layer Peeling/Adding Algorithm

Layer Peeling/Adding algorithm actually contains two sub-algorithms which use very similar approaches but totally opposite directions. The Layer Peeling (LP) algorithm receives the target spectrum as the input and output the distribution of the effective indices. The Layer Adding (LA) algorithm receives the effective index distribution as the input, and gives the spectrum as the output. In this sense, Layer Adding and Transfer Matrix Method have the same purpose, although Layer Adding is much faster than the Transfer Matrix Method. The details of LP and LA are discussed below. The present disclosure follows the notation from [19]. Some other good references of LP and LA can also be found in [24] [29] [30].

First of all, starting from (2.20), the transfer matrix Tⱼ of the jₜₕ segment is decomposed as the multiplication of two sub-matrices.

$$\begin{matrix}{T}_{j} = {T}^{Δ} {T}_{j}^{ρ} \\ where & ( 2.24 ) \\ {T}^{Δ} = ⌊ \begin{matrix}exp ( i δΔ ) & 0 \\ 0 & exp ( - i δΔ )\end{matrix} ⌋ & ( 2.25 ) \\ {T}_{j}^{ρ} = {( 1 - {\vert {ρ}_{j} \vert}^{2} )}^{- 1 / 2} ⌊ \begin{matrix}1 & - {ρ}_{j}^{*} \\ - {ρ}_{j} & 1\end{matrix} ⌋ & ( 2.26 )\end{matrix}$$

This is done by simplifying the transfer matrix of each segment into a propagation matrix T^{Δ} and a reflection matrix Tⱼ^{ρ}. In the propagation matrix Tⱼ^{ρ}, we only consider the propagation of light, so only the optical phase changes by exp(iδΔ). In the reflection matrix T^{ρ}ⱼ light from the jₜₕ segment sees the effective index of the (j+1)ₜₕ segment, so some of the forward-propagating power might be reflected. T^{Δ} is obtained from T by letting q→0, and Tⱼ is^{ρ} obtained from T by letting q→∞ while holding qΔ to be a constant. ρ is the complex reflection coefficient, and it is related to q in the following equations:

$$\begin{matrix}{ρ}_{j} = - tanh ( \vert {q}_{j} \vert Δ ) \frac{{q}_{j}^{*}}{\vert {q}_{j} \vert} & ( 2.27 ) \\ {q}_{j} = - \frac{1}{Δ} {tanh}^{- 1} ( \vert {ρ}_{j} \vert ) \frac{{ρ}_{j}^{*}}{\vert {ρ}_{j} \vert} & ( 2.28 )\end{matrix}$$

From (2.24) (2.25) (2.26) we can write u(z+Δ) and v(z+Δ) as

$$[ \begin{matrix}u ( z + Δ , δ ) \\ v ( z + Δ , δ )\end{matrix} ] = [ \begin{matrix}exp ( i δΔ ) & 0 \\ 0 & exp ( - i δΔ )\end{matrix} ] {( 1 - {\vert {ρ}_{j} \vert}^{2} )}^{- 1 / 2} [ \begin{matrix}1 & - {ρ}_{j}^{*} \\ - {ρ}_{j} & 1\end{matrix} ] [ \begin{matrix}u ( z , δ ) \\ v ( z , δ )\end{matrix} ] \qquad ( 2.29 )$$

It should be noted that the reflectivity is a function of z and δ and it can be written as

$$\begin{matrix}r ( z , δ ) = \frac{v ( z , δ )}{u ( z , δ )} & ( 2.30 ) \\ r ( z + Δ , δ ) = \frac{v ( z + Δ , δ )}{u ( z + Δ , δ )} & ( 2.31 )\end{matrix}$$

Therefore, from (2.29) (2.30) (2.31) we obtain the following two key equations

$$\begin{matrix}r ( z + Δ , δ ) = exp ( - i 2 δΔ ) \frac{r ( z , δ ) - ρ ( z )}{1 - {ρ}^{*} ( z ) r ( z , δ )} & ( 2.32 ) \\ r ( z , δ ) = \frac{r ( z + Δ , δ ) + ρ ( z ) exp ( - i 2 δΔ )}{exp ( - i 2 δΔ ) + {ρ}^{*} ( z ) r ( z + Δ , δ )} & ( 2.33 )\end{matrix}$$

These two equations above provide the foundation for designing the complex waveguide Bragg grating 150. Eq. (2.32) is the Layer Peeling equation, and Eq. (2.33) is the Layer Adding equation. (2.32) allows us to obtain the reflectivity and the effective index of the (j+1)ₜₕ segment, if we already have the reflectivity and the effective index of the jₜₕ segment. (2.33) does the reverse. It calculates the reconstructed spectrum (for comparison with the original target spectrum) from the calculated effective indices.

A key point to note is the physical meaning of Δ, δ and r(z, δ). As discussed before, Δ is the physical length of each segment used in LP/LA algorithm. δ is the wavelength detuning from the central resonance wavelength. So although the wavelength λ does not appear in (2.32) and (2.33), it has been implicitly represented by the term δ. r(z, δ) is the reflectivity r versus wavelength δ (now we know δ is just another expression of λ) at position z. So r(0, δ) is the original reflectivity spectrum seen from the beginning of the whole grating, r(Δ, δ) is the reflectivity spectrum seen from the beginning of the 1ₛₜ grating segment, and r(2Δ, δ) is the reflectivity spectrum seen from the beginning of the 2_{nd} grating segment, etc.

A simple analogy is shown below so the readers can understand the LP/LA algorithm better. Suppose there is an onion with a special shape (it may not be perfectly spherical, just like the fact that real applications may not have good-looking simple spectra). The onion is composed of many many layers, and each layer of the onion carries some specific information (thickness, any spot or irregularity for that layer, etc) about that layer, so if we peel this onion layer by layer we could know how the onion is constructed in detail. There is only one rule: to see the jₜₕ layer we first have to peel off the (j−1)ₜₕ layer. So first of all, the outermost layer (the 1ₛₜ segment) is peeled off, and its information (q, ρ, and n_{eff}) is written down (for later reconstruction), revealing the 2_{nd} layer. Then the 2_{nd} layer is peeled off and recorded, and then the 3_{rd} layer, the 4ₜₕ layer, so on and so forth. The peeling occurs in an iterative and sequential order. Finally, all the layers of the onion are peeled off, and the complete information of the onion is recorded. From these recorded information of layers we are able to reconstruct the same onion perfectly later on. This is exactly how the Layer Peeling works.

In this analogy, the original shape of the onion (without any peeling) is the target reflection spectrum which usually has a special shape, and the information of different layers is the effective indices of different discretized segments in the grating.

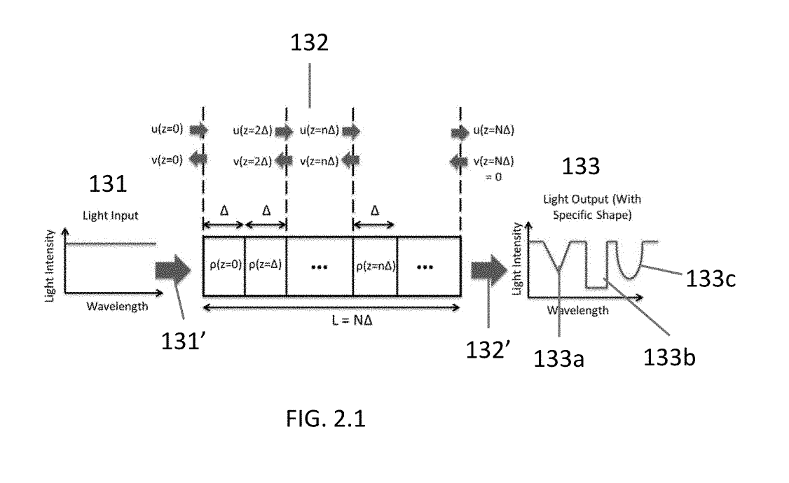

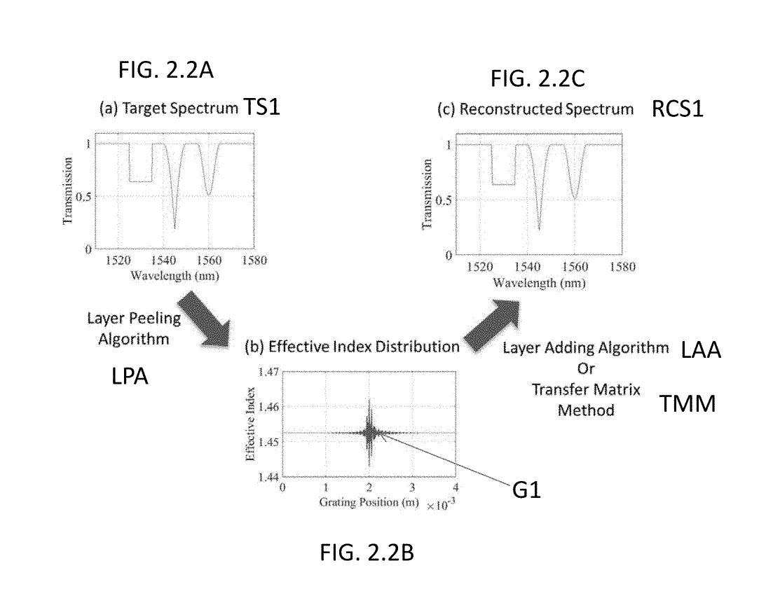

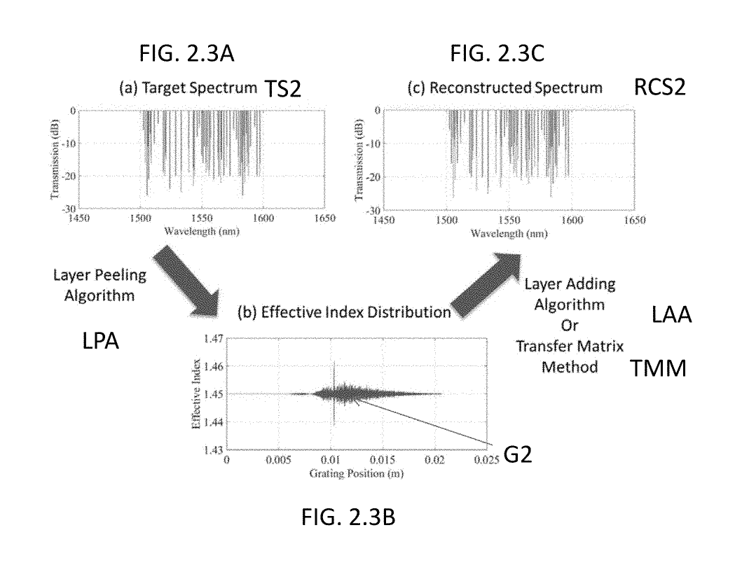

Referring to FIG. 2.1, the LP/LA algorithm works exactly in the same way to design the optical black box 132 in FIG. 1.3. In the LP/LA algorithm, the overall grating is discretized into many small segments, each with a length of Δ. The total length of the grating is L=NΔ. Effective indices for all these segments can be calculated precisely using (2.32) one by one. The reconstructed spectrum can then be checked using (2.33).

From the initial target reflectivity spectrum r(z=0, δ), ρ(z=0) is obtained, which corresponds to the coupling coefficient of the 1st segment of the grating. Then using Eqn. 2.32, r(z=Δ, δ) can be calculated, which is essentially the reflectivity spectrum seen from the beginning of the 2nd segment of the grating. Then ρ(z=Δ) is obtained from the value of r(z=Δ, δ). As a next step, r(z=2Δ, δ) and ρ(z=2Δ) are calculated. This procedure can be iterated until information of all those grating segments are found.

LA is just the reverse of LP, and it is used to evaluate the performance of a grating, assuming the effective index profile is obtained already. It is like obtaining the overall shape of a complete onion by assembling all the layers together. At first, we start from the innermost layer (which corresponds to the last segment of the grating). Then the 2nd layer is added on top of the innermost layer. Then the 3rd innermost layer is added. This iterative process comes in a reverse sequence compared to LP. Finally, when all the layers are assembled together, the outer surface of the onion will be presented in a specific shape (which corresponds to the reconstructed reflection spectrum). Hopefully, this is the desired shape that is required to design.

The importance of LP/LA is that by using the LP/LA algorithm, any types of onions (optical filters) can be designed, analyzed and reconstructed.

One more property of the LP/LA algorithm is that (2.32) only gives the distribution of effective index of the grating, but it does not indicate the exact material system and platform upon which the grating will be implemented. Therefore, the LP/LA algorithm introduced here can be applied to all the optical filter structures and platforms. In practice, this algorithm can be applied for both FBG and WBG platforms.

2.4 Discrete Fourier Transform & Target Spectrum Preparation

In the previous section, we derived equations for Layer Peeling and Layer Adding algorithms. And it should be clear now that q(z), ρ(z) and n_{eff}(z)−n0(z) actually all indicate the same thing: the effective index variation. The current question is: what is the relation between the effective index n_{eff}(z) of a certain segment and the term r(z, δ), the reflectivity spectrum seen from the beginning of that segment?

In order to answer this question, let's write the equation of the inverse Discrete Fourier Transform (DFT) in the following way:

$$h ( j ) = \frac{1}{M} {\sum }_{m} r ( m ) exp ( - \frac{i 2 π jm}{M} ) , j = 0 , 1 , 2 , … \qquad ( 2.34 )$$

(2.34) is the inverse DFT equation which gives the impulse response h(j), starting from the discretized reflectivity spectrum. M is the number of spectral points in the algorithm. Let us recall that r(z, δ) is the reflectivity spectrum seen from the beginning of the location z versus wavelength δ. And it is important to notice that the effective index of the segment in the location z corresponds only to the first element of the impulse response h(0). The reason is that if we send an impulse to the grating, h(0) will be affected by the 1ₛₜ segment of the grating only, since light at that time does not have enough time to travel to the other (2_{nd}) segments. This rule applies for all the layers, so ρ(z)=h(0). Therefore

$$p ( z ) = \frac{1}{M} \sum r ( z , δ ) \qquad ( 2.35 )$$

Also, in order for the DFT to work correctly, there is a relation between Δ in the time domain and the overall spectral detuning range δ_{w} in the frequency domain, which is shown below in (2.36). A whole step-by-step process of the algorithm and all these parameters will be discussed in the next section.

$$Δ = \frac{π}{{δ}_{ω}} \qquad ( 2.36 )$$

There is one last problem before we can run the algorithm correctly: the target spectrum needs some special treatment [19] [20]. If we take the inverse DFT to the original target spectrum (the default reflectivity spectrum is only a list of real numbers, without any imaginary part), the impulse response will probably have components for t<0. Such an impulse response does not exist in real filters and gratings. For real gratings, the impulse function h(t) always starts from t=0. Otherwise if h(t<0)≠0, it simply indicates that even before the impulse sees the grating, it already has some type of response from that grating!! That is not possible physically. In a physical world, we can never know what's inside a mysterious treasure box unless we first check its contents. No matter what detection methods we use (hands, eyes, or even X-rays), we have to first check it somehow. For a physical optical filter, the impulse response at time t<0 should always be zero.

Due to this consideration, the reflectivity spectrum used for the algorithm needs to be treated in the following way. An apodizing window (such as a Hanning function) is used to force the impulse function to become zero beyond a certain limit. Then the whole impulse response is shifted so that the first non-zero element starts at t=0. This new impulse response is then converted back to the new reflectivity spectrum using DFT. Finally, the new reflectivity spectrum can be used as a valid input to the Layer Peeling/Adding algorithm, so we can start our calculation and design.

2.5 Step-by-Step Guide of Layer Peeling/Adding Algorithm

The steps of the Layer Peeling/Adding algorithm are summarized below:
1) We start from a target reflection/transmission spectrum which can have any spectral shape. The spectrum is converted to a reflectivity spectrum so it could be used for the LP/LA algorithm.
2) An inverse discrete Fourier transform is performed on the reflectivity spectrum to get the impulse function. A Hanning function is then multiplied to the impulse function to force it to become zero beyond a certain range. The truncated impulse function is then shifted so that it starts at t=0. This becomes the realizable impulse function of the grating structure.
3) A forward discrete Fourier transform converts the realizable impulse function to the reflectivity spectrum r(z=0, δ).
4) ρ(z=0) is calculated from (2.35).
5) r(z=Δ, δ) is obtained from r(z=0, δ) and ρ(z=0) using (2.32).
6) Steps 4 and 5 are repeated to iteratively calculate the ρ(z) throughout the whole grating.
7) The effective index of the grating is derived from ρ_{z} using (2.17) (2.18) (2.28).
8) As long as the reflective index and ρ(z) are available, the reconstructed spectrum can be obtained with either the Transfer Matrix Method or the Layer Adding Method in (2.33).
9) The time complexity of this algorithm is O(M N), where M is the number of spectral sampling points in the spectrum, N is the number of discretized segments in the grating. Up to now, although the inverse-scattering problem seems quite difficult in the beginning, with the LP/LA algorithm it is just as simple as the forward-scattering program.

2.6 Design Examples of Layer Peeling/Adding Algorithm

Generally speaking, LP/LA algorithm can be applied to the synthesis of any random spectrum. As a comparison, traditional design methods can only regenerate spectrum of very limited shapes. To prove the capability of the LP/LA algorithm, two design examples are demonstrated below, showing the reliability and accuracy of the proposed LP/LA algorithm. For each design, we always start with a target transmission/reflection spectrum, then LP algorithm would tell us the effective index variation. Then the LA algorithm or the Transfer Matrix Method will show us the reconstructed spectrum. If the parameters of the grating are chosen appropriately, then the reconstructed spectrum should look very similar to the original target spectrum. The calculated effective index usually appears to have a strange shape and appears to be very aperiodic, and seen from naked eyes there seems to be no regularity at all. The advantages of the approach is that, with such seemingly “weird” effective index variations, different wavelengths will respond exactly how we want them to respond.

### 2.6.1 Design Example 1: An Arbitrary Spectrum

In the first example, a single grating G1 is designed whose filtering function has a special shape, with a rectangle, a triangle and an arc in its transmission spectrum. FIGS. 2A, 2B and 2C illustrate the synthesis of a grating with a special spectrum. FIG. 2.2A shows the original target spectrum TS1 which includes special shapes of a rectangle, a triangle and an arc. FIG. 2.2B is the calculated effective index nₑ variation, and FIG. 2.2C shows the spectrum calculated from the reconstructed grating RCS1. To obtain the grating profile, the LP algorithm LPA is first applied to the target spectrum TS1 in FIG. 2.2A, then the LA algorithm LAA is employed to calculate the spectrum from the synthesized grating in FIG. 2.2B. The synthesized grating is able to regenerate the target spectrum TS1 in FIG. 2.2A in this case as the reconstructed spectrum RCS1 in FIG. 2.2C. Note the similarity between the reconstructed spectrum RCS1 versus the target spectrum TS1.

2.6.2 Design Example 2: A Multi-Notch Filter with 150 Lines

FIGS. 2.3A, 2.3B and 2.3C illustrate the synthesis of a grating whose transmission spectrum (in dB) has 150 randomly-distributed notches between 1500 nm and 1600 nm, while each notch has its own specific suppression ratio.

FIG. 2.3A illustrates he target transmission spectrum TS2 with 150 notches.

FIG. 2.3B illustrates the effective index variation nₑ calculated using the Layer Peeling algorithm LPA

FIG. 2.3C illustrates the reconstructed spectrum RCS2 obtained from the calculated effective index in FIG. 2.3B.

More particularly, in this example, a very complex grating G2 is to be synthesized, which has 150 randomly-distributed narrow notches in the transmission spectrum. To make it more random and arbitrary, each of the notches will have its own suppression ratio. Again, the reconstructed grating RCS2 regenerates the original target spectrum TS2 successfully. LP/LA algorithm still works perfectly in this case.

From these two examples, the power and potential of our LP/LA algorithm is fully demonstrated. In the theory which is assumed to be lossless, the target spectrum can be either a reflection spectrum or a transmission spectrum, since they just add up to unity. In reality however, if a WBG is fabricated, some of the incoming light may experience the scattering loss or the radiation loss, which can be caused by the stepped waveguide widths due to the discretization process. Therefore, the detailed shape of the grating (e.g. the profile of the widths of the WBG) has to be determined as explained below in section 3. The information of the effective index variation obtained from the LP/LA is just a start for designing the real grating device, a 3-dimensional structure that can be fabricated and tested experimentally.

### 3: Design & Simulation

### 3.1 From the LP/LA to Designing a Real CWBG

From the previous section 2, it has been proven that by using the LP/LA algorithm, a grating profile can be calculated for any random spectrum. The output of the LP/LA algorithm gives the coupling coefficient q(z) (also sometimes called the grating profile) of the grating directly, but that does not indicate anything about the detailed structure of the grating. To realize a physical grating, we need to obtain its effective index variation. In this section, a design procedure is described so a real CWBG can be synthesized.

The core part of designing a CWBG is to find an appropriate waveguide structure so that the grating profile q(z) can be realized by fabrication. The amplitude of q(z) reflects the change of the effective index at location z, which also denotes the strength of reflection at that point. q(z) and the change of the effective index are related by the following equation:

$$\vert q ( z ) \vert = \frac{πΔ n ( z )}{λ} \qquad ( 3.1 )$$

while the effective index of the waveguide at position z can be written as

$$n - {n}_{0} = Δ n ( z ) cos ( \frac{2 π}{Λ} z + θ ( z ) ) \qquad ( 3.2 )$$

Here, n₀ is the average effective index, and the real effective index is varying in a sinusoidal way, controlled by the amplitude Δn(z), the period Λ and the phase θ(z). For a practical CWBG, q(z) will vary aperiodically along the z direction of the grating. To analyze the real change of the effective index, let us assume that the maximum amplitude of q(z) is about 40 cm⁻¹ [8]. As a consequence, Δn(z) will also vary according to q(z). At the wavelength of 1550 nm, the maximum value of Δn(z) is about

$$Δ {n ( z )}_{max} = \frac{\vert {q ( z )}_{max} \vert λ}{π} ∼ 0.002 \qquad ( 3.3 )$$

Therefore, the difference between the maximum effective index and the minimum effective index needs to be about 0.002×2=0.004, which is the range over which n(z) can vary. Considering the limitation of practical e-beam lithography, it is reasonable at first to assume that 20 discrete waveguide widths are written in order to realize a CWBG, whose effective indices cover this region of about 0.004. Therefore, at first thought we can roughly divide 0.004 by 20, which means that the real effective indices need to vary as n_{avg}−0.002, n_{avg}−0.0018, n_{avg}−0.0016, . . . , n_{avg}, . . . , n_{avg}+0.002. The number 20 is just an assumption in the beginning, and if a more precise CWBG is required in the future, 100 or even more discrete waveguide widths may be necessary. For a FBG which is photosensitive, the effective index variation can be realized by adjusting the intensity of the interferometer, or the period/phase of the phase mask. On the other hand, for a WBG with a planar structure, the effective index variation is made possible by changing some parameters of the waveguide, for example, by varying the width of the waveguide core in different positions of the grating. Obviously, if the width of the waveguide can only change by a very small range, for instance if the width can only vary from 1.000 μm to 1.001 μm, then such a narrow waveguide width step will be impossible even using the state-of-the-art e-beam lithography (EBL). On the other hand, if the width is made to change too much, say from 0.5 μm to 1.5 μm, then the scattering loss caused from the many periods of the CWBG will be too large and will affect the overall transmission severely. A delicate balance needs to be established here.

In [7], a comparison between a ridge waveguide (2-layer structure) and a strip waveguide (1-layer structure) was made on the SOI platform. A ridge waveguide cross-section was determined to be preferable, since the change of the waveguide width was large enough to be written by lithography. Ref. [22] [23] also utilize this kind of ridge waveguide for implementing a weak WBG.

According to embodiments of the present disclosure, a 1-layer strip waveguide of Si3N4/SiO2 is actually more appropriate, which also has the additional advantage of only one lithography step and one etching step.

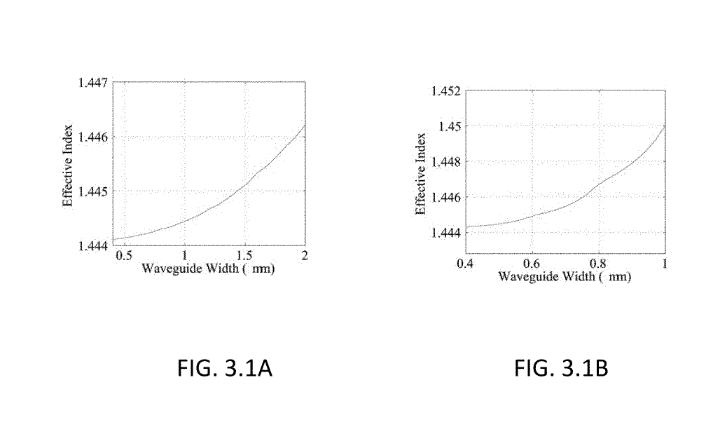

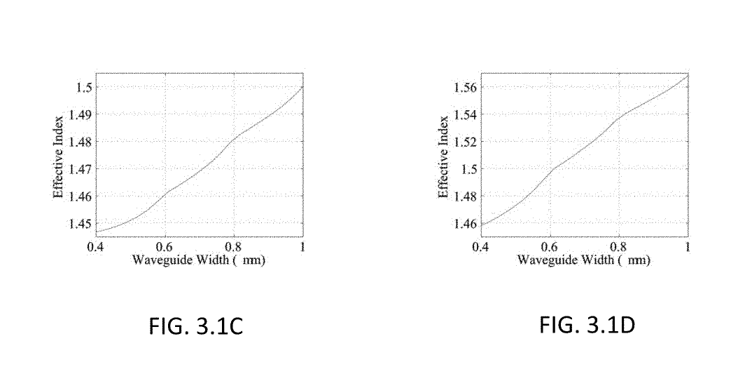

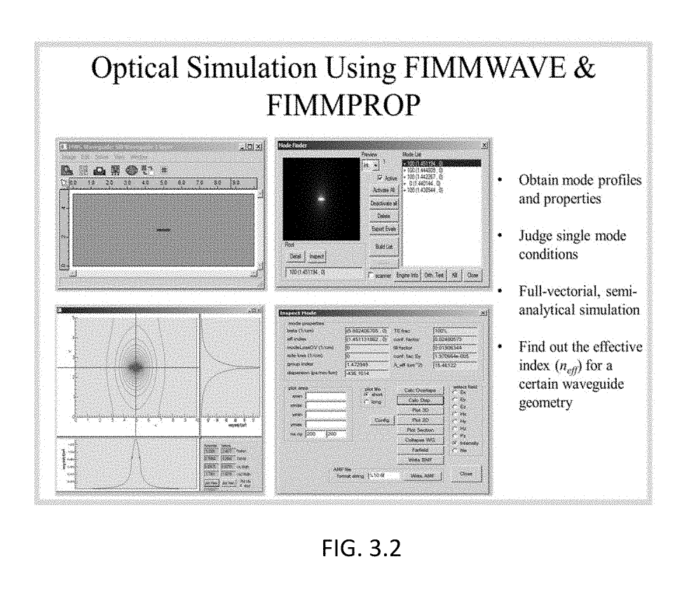

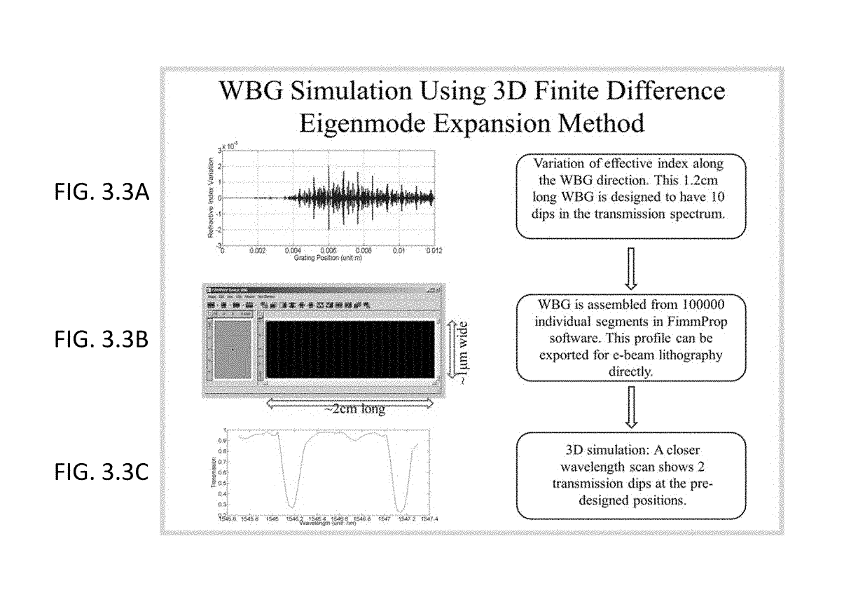

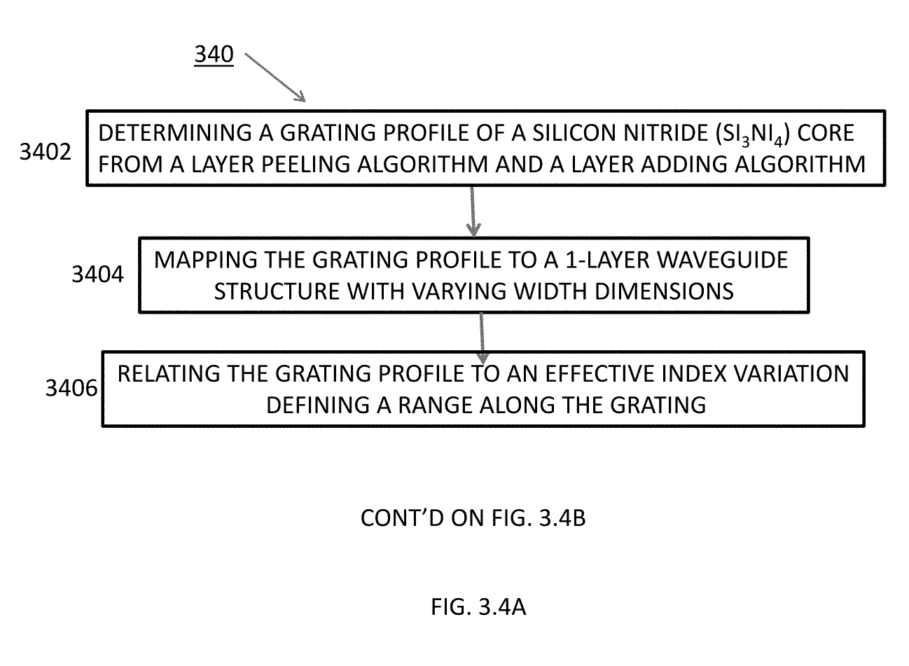

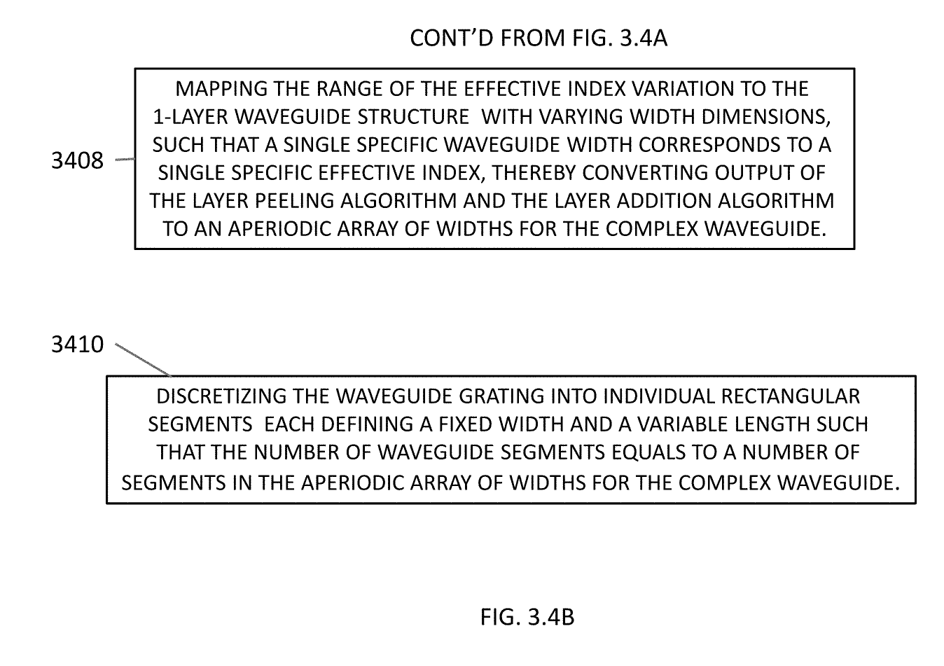

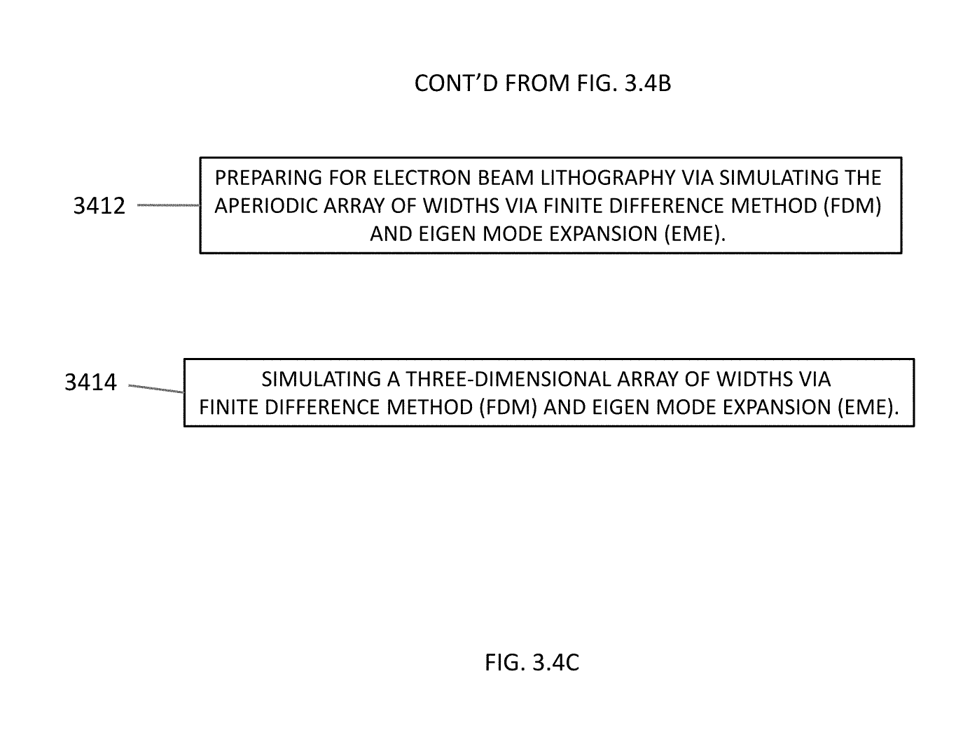

To explain in more detail, some simulation is done and the results are shown in FIGS. 3.1A, 3.1B, 3.1C and 3.1D which show the theoretically expected change of the effective index as the width of the Si3N4 waveguide varies, when the thickness of the Si3N4 waveguide is 50 nm, 100 nm, 200 nm and 300 nm respectively.

More particularly, FIG. 3.1A illustrates the core width of the Si3N4/SiO2 waveguide varies but its core thickness is kept constant as 50 nm.

FIG. 3.1B illustrates the core width of the Si3N4/SiO2 waveguide varies but its core thickness is kept constant as 100 nm.

FIG. 3.1C illustrates the core width of the Si3N4/SiO2 waveguide varies but its core thickness is kept constant as 200 nm.

FIG. 3.1D illustrates the core width of the Si3N4/SiO2 waveguide varies but its core thickness is kept constant as 300 nm.

Suppose now that a Si3N4 waveguide thickness of 200 nm or 300 nm is used to fabricate the WBG 150 of FIG. 1.5.

In order to get an effective index change of 0.004, the width can only vary by ˜50 nm and ˜20 nm, respectively. If we simply divide this number by 20, this gives a width step of 2.5 nm and 1 nm, respectively. This means that in order to fabricate this CWBG, a series of waveguide widths such as 1 μm, 1.001 μm, 1.002 μm, . . . , etc., need to be patterned clearly. It is impossible to write such small steps of the waveguide widths, even with the current state-of-the-art EBL system. On the other hand, if the thickness of the Si3N4 waveguide is only 50 nm, then even when the waveguide width varies from 0.4 μm to 2 μm, the change of the effective index is only about 0.002. As a consequence, large scattering losses will occur if the thickness of the WBG is only 50 nm.

Fortunately, if the thickness of the Si3N4 waveguide is 100 nm, then, when the waveguide width changes from 0.4 μm to 0.9 μm, the effective index is changed by about 0.004. In this case, it is possible to write various waveguide widths varying between 0.4 μm and 0.9 μm using EBL with enough resolution, and the scattering loss may also be tolerable in practice. Moreover, as described below, it is shown that such an Si3N4/SiO2 grating is inherently compatible with the high coupling efficiency of a Si3N4/SiO2 waveguide coupler, since 100 nm thick, 500 nm wide Si3N4 waveguide will give a coupling efficiency of 84% to SMF28 fiber, 100 nm thick, 700 nm wide Si3N4 waveguide will give a coupling efficiency of 92% to SM1500G80 fiber, and 100 nm thick, 900 nm wide Si3N4 waveguide will give a coupling efficiency of 96% to UHNA3 fiber. The required waveguide widths would then need to be within the range of 0.4-0.9 μm in order to realize the required range of effective index variation. Therefore, the high-efficiency, easy-to-fabricate Si3N4 waveguide couplers as concurrently disclosed in U.S. provisional applications 62/360,814 and 62/530,441 that are incorporated herein by reference, and to which priority is claimed, would be completely compatible with the fabrication of the CWBG 150 here.

### 3.2 Assembling & Simulation of CWBG

The procedure to design the real CWBG is now understood: from the LP/LA algorithm, the grating profile q(z) or ρ(z) is obtained initially, which can be related to the effective index variation n(z) along the grating. This range of the effective index variation is then mapped to a 1-layer waveguide structure with varying widths. It means one specific waveguide width will correspond to one specific effective index. In reality, the mapping is realized by a Matlab script with a loop.

As illustrated in FIG. 3.2, this mapping process is realized by using FIMMWAVE/FIMMPROP from Photon Design to execute an optical simulation using FIMMWAVE/FIMMPROP to calculate the mode profile parameters and to map the effective index to a real waveguide design. A simple 1-layer waveguide is drawn in the software, and the effective index is plotted versus the width of the waveguide. So the mapping process can be executed, which converts the output of LP/LA algorithm to an aperiodic array of width for a complex waveguide.

For a real CWBG which is about 2 cm-3 cm in length, it is generally discretized into 200,000-300,000 small individual segments. Each segment is a tiny rectangle, with a length of 100 nm and a fixed width obtained from the mapping process before. The number of waveguide segments equals to the numbers in the grating's effective index array. In other words, if there is 200,000 points in the effective index profile, there will also be 200,000 small segments which constitute the whole CWBG.

So far, it is possible to obtain the widths of the grating, and now a complete GDSII file is required for the subsequent EBL. Since these 200,000 segments are not periodic at all, another Matlab script is written to remotely control the assembling of CWBG in FIMMWAVE/FIMMPROP. The advantage is that, after the grating assembling, as shown in FIGS. 3.3A, 3.3B and 3.3C, the 3D aperiodic grating structure can be simulated using Finite Difference Method (FDM) and Eigen Mode Expansion (EME) in FIMMPROP.

More particularly, FIG. 3.3A illustrates assembling and 3D simulation of a complex waveguide Bragg grating according to embodiments of the present disclosure utilizing FIMMWAVE/FIMMPROP with the assistance of Matlab scripts wherein the width/profile of the CWBG is highly aperiodic for a random spectrum;

FIG. 3.3B illustrates that the profile can be exported to e-beam lithography directly;

FIG. 3.3C illustrates that spectral notches occur at;their prescribed positions in the spectrum;

Thus, the process of effective index mapping, grating assembling and 3D simulation is shown in FIG. 3.2 and FIGS. 3.3A-3.3C.

In contrast to the prior art, to implement the embodiments of the present disclosure, a complex waveguide grating was constructed with 200,000 aperiodic segments. Although FIMMWAVE/FIMMPROP is reliable software, it is time-consuming to assemble all the 200,000 individual segments in FIMMWAVE/FIMMPROP. The embodiments of the present disclosure are the first ever simulation of such a complex waveguide grating with so many aperiodic segments. In the 3D simulation, FIMMWAVE/FIMMPROP only recognizes that the waveguide is a complex waveguide with varying width, and there are no accommodations in the software to address the configuration wherein the width is arranged and assembled in such an unusual way. The 3D simulation requires from a few days to a few weeks 24/7 unceasingly to execute, as FIMMWAVE/FIMMPROP has to calculate the overlap integral for 199,999 (200,000−1) interfaces one by one. And each run is only for a single wavelength. In the spectrum, there may be 1000 or even more spectral points, so the overall time is just 1000 times that. A future powerful upgrade of FIMMWAVE/FIMMPROP to support such intensive calculations would yield much faster simulation results.

The specific method steps for the method 340 of designing the complex waveguide Bragg grating 150 are illustrated in FIGS. 3.4A-3.4C. More particularly, in FIG. 3.4A, the method begins with step 3402 of determining a grating profile of the silicon nitride (Si₃Ni₄) core from a Layer Peeling algorithm and a Layer Adding algorithm and step 3404 of mapping the grating profile to a 1-layer waveguide structure with varying width dimensions.

The method includes step 3406 of relating the grating profile to an effective index variation defining a range along the grating and, in FIG. 3.4B, step 3408 of mapping the range of the effective index variation to the 1-layer waveguide structure with varying width dimensions, such that a single specific waveguide width corresponds to a single specific effective index, thereby converting output of the Layer Peeling algorithm and the Layer Addition algorithm to an aperiodic array of widths for the complex waveguide.

In FIG. 3.4B, the method includes step 3410 of discretizing the waveguide grating into individual rectangular segments each defining a fixed width and a variable length such that the number of waveguide segments equals to a number of segments in the aperiodic array of widths for the complex waveguide.

In FIG. 3.4C, the method includes step 3412 of further preparing for electron beam lithography via simulating the aperiodic array of widths via finite difference method (FDM) and eigen mode expansion (EME).

In one embodiment, the step 3412 of simulating the aperiodic array of widths via finite difference method (FDM) and eigen mode expansion (EME) includes step 3414 of simulating a three-dimensional array of widths via finite difference method (FDM) and eigen mode expansion (EME).

### 4: Fabrication & Experimental Results

### 4.1 Nano-Fabrication Process

FIG. 4.1 illustrates the fabrication procedures of the Si3N4/SiO2 waveguide coupler with waveguide core thickness of 100 nm. The end-facet cleaving process does not need high position accuracy, because a narrow straight waveguide on both ends of the device is added. The end-waveguide geometry is optimized to achieve high coupling efficiency, and the cleaving should be superior as long as it occurs somewhere on this end straight waveguide. Referring to FIG. 4.1 in conjunction with FIG. 1.5, the fabrication of or method of manufacturing 400 of complex waveguide Bragg grating 150 starts by providing silicon wafer or substrate 152 with a 5 μm thermal SiO2 layer on top. A 100 nm thick Si3N4 layer is first deposited using low-pressure chemical vapor deposition (LPCVD). Then the profile of the CWBG is patterned by e-beam lithography (using a Raith e-line instrument), and a chromium hard mask is made by e-beam deposition and subsequent lift-off. After that, reactive-ion etching (RIE) is performed, followed by chromium removal and another 5 μm SiO2 film deposition from plasma-enhanced chemical vapor deposition (PECVD), as the upper cladding layer. Finally, the thickness of the sample is polished to about 100 μm from the back-side, which facilitates ease of subsequent end-facet cleaving. Because the CWBG has a simple one-layer structure, the fabrication process requires only one lithography step and one etching step. We control the stitching error by doing very precise writefield (WF) alignment, and also by overlapping neighboring WFs slightly with each other. The whole device is stitched and connected without any stitching gaps between two WFs. It typically takes about 1-1.5 hours to write a CWBG.

The entire nano-fabrication process steps are listed in Appendix A of U.S. provisional application 62/530,441 that is incorporated herein by reference in its entirety.

More particularly, still referring to FIGS. 1.5 and 4.1, method of manufacturing 400 of the waveguide Bragg grating 150 includes in step 410 providing a silicon wafer or substrate 152 having a thickness, in one embodiment of 500 μm, with a 3-15 μm thermal SiO2 layer 1561 grown on a first surface 152′ of the silicon wafer or substrate 152.

In step 420, via low-pressure chemical vapor deposition (LPCVD) 415, the method includes depositing Si3N4 layer 154, having a thickness in one embodiment of 100 nm, on first surface 156′ of the 3-15 μm thermal SiO2 layer 156.

In step 430, via electron beam lithography (EBL) 425, the method includes patterning a profile of the waveguide Bragg grating 150 in a layer of poly(methylmethacrylate) PMMA 158 disposed on first surface 154′ of the Si3N4 layer 154.

In step 440, in conjunction with E-beam deposition 435, the method include providing a chromium hard mask 160 on first surface 154′ of the Si3N4 layer 154 and etching the Si3N4 layer 154 Other masks can be used for etching a pattern, apart from chromium. For instance, other metals apparent to those skilled in the art can be used. Chromium is just one option.

In step 450, in conjunction with reactive ion etching 445, the method includes removing the chromium hard mask 160 and performing reactive ion etching of the Si3N4 layer 154 to yield an Si3N4 layer 1540 on the thermal SiO2 layer 156 having a width dimension equal to the width dimension of the chromium hard mask 160, wherein the width dimension is reduced as compared to the width dimension of the thermal SiO2 layer 156 prior to reactive ion etching 445.

In step 460, in conjunction with a silane based plasma-enhanced chemical vapor deposition of SiO2 process 455a or low-stress tetraethoxysilane (TEOS) plasma-enhanced chemical vapor deposition (PECVD) process 455b, the method includes depositing 3-15 μm low-stress SiO2 layer 1562 on top of the wafer via the silane based plasma-enhanced chemical vapor deposition of SiO2 process 455a or the low-stress tetraethoxysilane (TEOS) plasma-enhanced chemical vapor deposition (PECVD) process 455b to encase the Si3N4 layer 1540 in SiO2.

In one embodiment, prior to method step 480, wherein the method includes as step 475 cleaving end-facets 158a and 158b (see FIG. 1.5), of the silicon wafer or substrate 152 the Si3N4 layer 1540 and the SiO2 layers 1561 and 1562, in step 470, the method may include, as step 465 polishing the second surface or rear side surface 152″ of the silicon wafer or substrate 152 to form thereby silicon wafer or substrate 1520 have a reduced thickness compared to silicon wafer or substrate 152, wherein the second surface or rear side surface 152″ is opposing the first side or surface 152′ to form thereby the complex waveguide Bragg grating 150.

Step 480 includes yielding the complex waveguide Bragg grating 150 by step 475 of cleaving end-facet to form thereby complex waveguide Bragg grating 150.

It should be noted that polishing the second surface 152″ to reduce the thickness of the Si substrate 152 along the y-z plane is realized by polishing the Si layer from the bottom or second surface 152″. It is easier to put a cleave mark in upper surface 1562′ of SiO₂ layer 1562 and then separate (cleave) the waveguide Bragg grating 150 by applying a force down from the top toward the bottom of the sample (force along the x-y plane) to result in facets 158a and 158b on the near and far ends in the z-direction and which extend across the y-direction of waveguide Bragg grating 150. If the waveguide Bragg grating 150 is thicker, it is more difficult to break the sample and the surface of the cleaved facet (in the x-y plane) might not be smooth anymore because the cleavage does not occur along a crystal cleavage plane. The Si causes the cleave to occur along a cleavage plane because of the Si crystalline structure. The SiO2 and the Si3N4 are not crystals. The Si layer 152 is much thicker than either the SiO2 or the Si3N4 layers.

In FIG. 1.5, due to the polishing step 465, the thickness of the facets 158a and 158b are shown in the x-direction not to extend entirely to include the pre-polished configuration of Si layer or substrate 152.

It should be noted that while polishing the second surface 152″ assists in cleaving the sample, strictly speaking, the polishing is not necessary. Having a properly cleaved facet allows for optically coupling light into the waveguide 150 from a fiber.

Thus, the waveguide facets 158a and 158b are on the edges of the wafer, at normal (90 degrees) angle from the surface of the wafer. Alternatively, light can also be coupled in the waveguide using an on-chip grating that allows coupling of light at, or near, normal incidence to the wafer surface.

As defined herein, a film with stress level less than of order 100 MPa is a low stress film.

A SiO2 film grown using silane by PECVD would have losses of order few dB/cm. The stress in the film would be of order 3 GPa. By reducing the stress, the number of microcracks and the amount of light scattering in the waveguide are reduced, which translate to a lower propagation loss (<1 dB/cm), which would be desirable but not required for the basic demonstration of the complex waveguide Bragg grating 150 designed and constructed according to the present disclosure. An approach for reducing the stress in the complex waveguide Bragg grating 150 to a level less than 100 MPa is to perform TEOS based SiO2 deposition using PECVD.

Other deposition techniques apart from PECVD and other materials apparent to those skilled in the art are also contemplated.

In addition, a thermal anneal step on the sample at temperatures of order 1000-1200° C. for 2-4 hours might be beneficial for reducing absorption due to OH, Si—H, and N—H bonds in the spectral region between 1300-1600 nm from a few dB/cm to appreciably less than <1 dB/cm.

### 4.2 Aspects of E-Beam Lithography (EBL)

Since the method 400 involves nano-fabrication, it is important to show some Scanning Electron Microscope (SEM) figures of our real waveguide patterns produced by the method. For the presently disclosed CWBGs 150 which have continuously-varying waveguide widths and small theoretical feature size of less than 10 nm, a stable EBL with high resolution is highly beneficial.

### 4.2.1 Settings for Focus, Stigma and Aperture

One of the major issues with current Raith EBL systems involves human factors in operating the machine. The reason is that all the adjustments about focus, stigma and aperture are judged and optimized manually by the machine operator. These adjustments (especially stigma adjustments) can be somewhat difficult for those not having a great deal of SEM experience. It requires practice and real sample processing to learn and become familiarized. FIG. 4.2 demonstrates a good contamination-spot 420 with decent focus, aperture and stigma. The settings/adjustments about focus, stigma and aperture are important for a successful EBL pattern. The contamination spot 420, burned here using left-click quick-burn in the Raith system, should have a diameter of about only 20-30 nm. This spot should be sharp and clear all over its outer circumference under the magnification of at least 100K. This is an important step before real patterning begins.

### 4.2.2 Active Focus-Adjustment for Large Patterns: Laser Height Sensing (LHS)

Another small but really useful procedure is the Laser Height Sensing (LHS). LHS is an active focus-adjustment technique for large patterns with large dimensions and many writefields, especially centimeter-sized waveguides and waveguide gratings according to the present disclosure.

FIG. 4.3A and FIG. 4.3B demonstrate very clearly why LHS is beneficial for large patterns. The basic principle of LHS is quite simple: a laser is projected onto the sample surface and is reflected and detected by the detector, which measures the height of the current writefield. The system then adjusts either the height of the sample or the working distance of the beam to guarantee perfect focus condition. Once it is switched on, LHS will be performed for focus-adjustment before the patterning of every writefield.

More particularly, FIG. 4.3A illustrates exposure of small designs, wherein laser beam 430 having a depth of focus d focuses on sample surface 432 having a writefield 434 to create a focus spot 434′. Since the focus spot 434 remains fixed, there is generally no height variation and the beam 430 is always well focused since the depth d of the beam is always much greater than variation in height of the sample 432.

FIG. 4.3B illustrates exposure of large designs wherein the laser beam 430 may become out of focus across the surface of sample 432 due to the depth of focus d being less than or equal to the height variation of the sample 432 due to a spreading focus area 434″ on writefield 434.

FIGS. 4.4A and 4.4B show the principle and operation of LHS clearly.

Although LHS is optional for Raith EBL system employed to perform the fabrication process for the complex waveguide Bragg gratings according to the present disclosure, it is recommended to use this function if the pattern has dimensions larger than a few millimeters. It is worth noting that on some of the newer EBL systems, such as those operating at 100 kV, LHS becomes a necessary step.

In FIG. 4.4A, automatic calculation of the working height distance is performed by a controller 436 for laser beam 430.

In FIG. 4.4B, the frequency of scanning one pixel, the time required for one scan of CCD-line, and the integration line for one pixel under automatic pixel control on a computer display are illustrated for the LHS operation of FIG. 4.3A. It is recommended that LHS be switched on for large patterns.

### 4.2.3 Stitching Error

Stitching error is also a very common problem in e-beam lithography, and it can have several causes. The beam will jump between neighboring writefields, and this can cause the two writefields to be stitched with an offset, as shown in FIG. 4.5, wherein FIG. 4.5 demonstrates stitching errors between two neighboring writefields (WF), caused during improper setting/alignment in the e-beam lithography.

More particularly, while the stitching is defined by crests spaced apart by 1.1 μm and troughs spaced apart by 1.4 μm, a stitch error 450 may occur between two writefields where the crests do not align and/or the troughs do not align.

On the Raith machine utilized to perform the nanofabrication process for the complex waveguide Bragg gratings of the present disclosure, there is a Fixed Beam Moving Stage (FBMS) configuration which can eliminate the stitching error. The reason why FBMS can eliminate the stitching error is actually quite simple: FBMS commands the beam to go from the beginning to the end without any jumps. A beam jump from one writefield to the next writefield causes the stitching error. When using the FBMS feature, the whole big pattern is no longer separated into small writefields. Instead, the beam will move continuously from one end of the waveguide to the other end with no jump.

However, FBMS handles only simple patterns, such as straight waveguides and circles. FBMS cannot write a CWBG with 200,000 individual segments, each with its own width. Secondly, FBMS does not allow the Laser Height Sensing, which is the feature of active focus-adjustment. The consequence is that using FBMS, the pattern will be perfectly focused only in one location, and will be more or less defocused in other positions.

Therefore, it is not recommended to use FBMS (unless stitching error is a very severe problem), because it cannot write complex waveguide gratings with constantly-varying widths, and it does not support LHS for active focus-adjustment.

To overcome the stitching error, a layer of conducting polymer (such as aqua-save) on top of the sample surface and a careful execution of the EBL process will greatly avoid stitching errors.

Finally, two SEM figures of an actual 47-notch grating are shown in FIGS. 4.6A and 4.6B. An EBL patterning like this will be proper for subsequent experimental characterizations.

FIG. 4.6A illustrates SEM figures of a real 47-notch grating of the joint section between two Δ segments (see Section 2 above for definition of Δ) which have different complex coupling efficiencies q(z).

FIG. 4.6B illustrates a section within one Δ segment.

### 4.3 Experimental Set-Up

FIG. 4.7 illustrates an experimental set-up for the waveguide performance measurement, showing two XYZ stages which hold input and output fibers, two microscope cameras for fiber/waveguide alignment and a waveguide sample mounted in the middle.

Referring to FIG. 4.7, to characterize the transmission spectrum of the CWBG 150, a trans-electric (TE) polarized broadband light source covering 1500 nm-1600 nm is used. The light travels in a polarization-maintaining (PM) fiber, PM1550-XP, and is launched into the CWBG with an automatic XYZ stage. The output light is collected from the other end of the CWBG with another XYZ stage, and is finally analyzed by an Optical Spectrum Analyzer (OSA, YOKOGAWA AQ6370C). The resolution of the OSA is 0.004 nm. In this case, the effective index is taken from the fundamental TE waveguide mode in the design, so both the fiber-rotator and the PM fibers are employed to guarantee the TE polarization of the input light.

### 4.4 Flow-Diagram of the Whole Theoretical and Experimental Procedures

FIGS. 4.7A through 4.7F illustrate jointly a complete flow diagram of the calculation, design, fabrication and characterization processes.

That is, FIGS. 4.7A through 4.7F illustrate the complex waveguide Bragg grating 150 shown in FIG. 1.5 together with the method 340 of designing the complex waveguide Bragg grating 150 as illustrated in FIGS. 3.4A-3.4C as described above, and the method 400 of manufacturing the complex waveguide Bragg grating 150 as illustrated in FIG. 4.1 as described above. FIGS. 4.7A through 4.7F also further describe the calculation and characterization processes.

FIG. 4.7A illustrates that the design of a specific CWBG device starts with a target transmission spectrum with an arbitrary shape or target spectrum TS3, in a similar manner as explained above with respect to target spectrum TS1 in FIG. 2.2A and TS2 in FIG. 2.3A.

In FIG. 4.7B, in a similar manner as shown and described above with respect to FIGS. 2.2B and 2.3B, the effective index profile or distribution is calculated/examined as in method step 3402 in FIG. 3.4A using the layer peeling LP/layer adding LA algorithm.

In FIG. 4.7C, as in method step 3404 in FIG. 3.4A, the effective index is mapped to the actual width profile of the CWBG 150.

In FIG. 4.7D, according to the method of manufacturing 400 described above with respect to FIG. 4.1, a single layer CWBG device 150 is implemented on a silica-on-silicon platform. as described above with respect to FIG. 1.5 and FIG. 4.1 In this case, the width is continuously varying in the y-direction, while the thickness remains the same. Light propagates along the z-direction.

FIG. 4.7E is an SEM picture showing a portion of the actual CWBG 150 with continuously varying width.

In FIG. 4.7F, via method step 485, performance of the CWBG device 150 is characterized experimentally and then via method step 490 the Experimental Spectrum ES is compared to the target spectrum TS3 in FIG. 4.7A.

As described above with respect to FIG. 1.5, the SiO2 layer 1561 and 1562, respectively, below and above the Si3N4 layer 1540 together have a thickness such that the guided wave does not extend significantly all the way to the Si substrate 1520 below (to avoid absorption of light) or to the air layer above the SiO2 layer 1562. Typically, the SiO2 layer 1561 and 1562, respectively, thickness below and above the Si3N4 layer 1540 should be between 2 and 15 um, depending how confined the light is in the guiding waveguide. The weakly guided mode would require a larger thickness of SiO2 and vice versa. The width and thickness of the Si3N4 layer are chosen such that the waveguide supports a single transverse electric (IL) or a single transverse magnetic (TM) mode or both.

### 4.5 Experimental Results

### 4.5.1 First Generation: 20-Notch CWBG

FIG. 4.8 shows as a comparison both the simulation results (light color plots) 481 and the experimental transmission spectrum results (dark color plots) 481 for the CWBG device 150, which removes 20 irregularly spaced narrow spectral lines between 1530 nm and 1560 nm simultaneously. The 3 dB bandwidths for all these spectral notches are 0.3-0.4 nm, in agreement with the simulation results. The sloping transmission vs. wavelength in FIG. 4.8 is due to the losses from O—H and N—H bonds near 1.5 μm associated with the PECVD process; these losses can be reduced via thermal annealing. The remaining losses are due to fiber-to-waveguide coupling at the two facets of the CWBG device and propagation/scattering loss through the waveguide.

TABLE 4.1 summarizes and compares the positions of the experimental transmission notches of the CWBG with its theoretical values. TABLE 4.2 lists the major parameters and experimental performance of the CWBG device. All the spectral lines are suppressed by at least 15 dB, while some of the deepest notches reach as much as 33.6 dB. The variance in the suppression ratios is due to the limited resolution of the current fabrication process. As explained above, the designed CWBG 150 has a width that varies between 800 nm and 1.6 μm, corresponding to the range of effective index variation (±0.0064). In order to further map each discretized width to the varying effective index precisely, a small width step is desirable. In this case, the actual waveguide widths are designed to be 800 nm, 808 nm, 816 nm, . . . , 1592 nm, 1600 nm, with a step of 8 nm. In other words, the continuously-varying effective index of ±0.0064 is sampled into (1600−800)/8+1=101 discretized values. Smaller steps (e.g. 4 nm or 2 nm) do not improve the CWBG performance in our simulations. This 8 nm width step can be considered ideal for CWBG 150 design, but in practice, such a small step cannot easily be patterned using a state-of-the-art e-beam lithography, because this length resolution stretches the capability of the instrument. This is why the suppression ratios in our experiment is not exactly the same for all the 20 notches.

FIG. 4.9 illustrates the effective index variation along the grating whose spectrum is shown in FIG. 4.8. The effective index is calculated from the Layer Peeling algorithm, and is varying in an aperiodic way.

It is worth noting that others have approached this same problem from the point of view of volume holography, using a 2-layer SOI waveguide structure fabricated by deep-UV lithography [22, 23]. Large differences between the theory and the experimental realization are observed. The theory assumes small index variation so the second-order reflections are neglected, which is good enough for weak gratings, but not suitable for gratings with both deep and narrow notches. By comparison, the LP/LA algorithm utilized herein according to the present disclosure makes no such assumptions, and can be applied to any arbitrary spectrum. Moreover, we experimentally demonstrate that one can design a CWBG with a simpler one-layer waveguide structure, fewer fabrication steps, deeper and narrower notches, and better spectral precision. This makes CWBG promising for various applications, especially in astrophysical observations.

TABLE 4.1
Comparison between the theoretical simulations and experimental results
for our first generation CWBG. Our goals were to reach spectral precision
(λ_{target} − λₑₓₚₑᵣᵢₘₑₙₜ) better than ±0.1 nm, 3 dB bandwidths (FWHM)
of about 0.3 nm, and suppression ratios larger than 15 dB.
All these technical requirements were achieved experimentally.

| Channel | | | λtarget − | Notch Depth |
|---|---|---|---|---|
| Number | λtarget (nm) | λexperiment (nm) | λexperiment | (dB) |
| 1 | 1532.000 | 1531.940 | 0.060 | 22.2 |
| 2 | 1533.000 | 1533.000 | 0.000 | 16.4 |
| 3 | 1535.000 | 1534.932 | 0.068 | 26.4 |
| 4 | 1536.000 | 1535.988 | 0.012 | 24.9 |
| 5 | 1537.000 | 1536.972 | 0.028 | 15.1 |
| 6 | 1538.000 | 1537.912 | 0.088 | 19.3 |
| 7 | 1540.000 | 1539.920 | 0.080 | 18.9 |
| 8 | 1541.000 | 1540.936 | 0.064 | 16.9 |
| 9 | 1542.000 | 1542.024 | −0.024 | 17.5 |
| 10 | 1544.000 | 1543.960 | 0.040 | 18.7 |
| 11 | 1545.000 | 1544.940 | 0.060 | 18.5 |
| 12 | 1546.000 | 1546.004 | −0.004 | 17.5 |
| 13 | 1547.000 | 1546.932 | 0.068 | 33.6 |
| 14 | 1548.000 | 1547.944 | 0.056 | 24.0 |
| 15 | 1549.000 | 1548.964 | 0.036 | 16.0 |
| 16 | 1550.000 | 1549.936 | 0.064 | 19.4 |
| 17 | 1554.000 | 1553.972 | 0.028 | 20.0 |
| 18 | 1556.000 | 1555.932 | 0.068 | 19.5 |
| 19 | 1557.000 | 1556.968 | 0.032 | 18.8 |
| 20 | 1558.000 | 1557.924 | 0.076 | 16.7 |

TABLE 4.2
Major parameters of the fabricated first generation CWBG device.

| Parameter | Value |
|---|---|
| Overall CWBG Length(L) | 2 cm |
| Length of Each Segment in LP/ | 10 μm |
| LA Before Discretization (Δ) | |
| Number of Segments in LP/LA | 2000 |
| Length of Each Discretized Segment (ΔL) | 100 nm |
| Number of Discretized Segments | 200,000 |
| Maximum Effective Index Variation | ±0.0064 |
| Si₃N₄ Core Width Range | 800 nm-1.6 μm |
| Si₃N₄ Core Thickness | 100 nm |
| SiO₂ Cladding Thickness | 5 μm top and 5 μm under |
| Number of Spectral Notches | 20 |
| Suppression Ratios | 15 dB-33 dB |
| 3 dB Bandwidth | 0.3-0.4 nm |
| Spectral Precision | ±0.1 nm |

### 4.5.2 Second Generation: 47-Notch CWBG

Based on the first generation of CWBG, we designed and fabricated the second generation of CWBG, which has 47 notches between 1510 nm and 1610 nm.

FIG. 4.10 illustrates the experimental transmission spectrum of these notches showing the removal of 47 prescribed narrow spectral lines simultaneously, and TABLE 4.3 and TABLE 4.4 provide a detailed comparison between theoretical and experimental spectral positions.

FIG. 4.11 illustrates the effective index variation of this grating that is shown in FIG. 4.10. The effective index is calculated from the Layer Peeling algorithm, and is varying in an aperiodic way Major parameters of this CWBG device are listed in TABLE 4.5. Again, even though the effective index seems chaotic, its transmission spectrum regenerates these notches very precisely. High spectral precision is achieved again.

It is noted that in FIG. 4.10 there is a large absorption dip 41 at the wavelength of 1500 nm. It is caused by the O—H and Si—H bonds introduced in the nano-fabrication process. In the next chapter, we will provide solutions to remove this large absorption dip.

The major parameters of this CWBG device are listed in TABLE 4.5.

TABLE 4.3
Comparison between the theoretical and experimental spectral positions
for our second generation CWBG. Please note the high spectral precision
(λ_{target} − λₑₓₚₑᵣᵢₘₑₙₜ) achieved with this grating.

| Channel Number | λ_{target} (nm) | λₑₓₚₑᵣᵢₘₑₙₜ (nm) | λ_{target} − λₑₓₚₑᵣᵢₘₑₙₜ (nm) |
|---|---|---|---|
| 1 | 1522.583 | 1522.636 | −0.05299996 |
| 2 | 1524.335073 | 1524.34 | −0.004927216 |
| 3 | 1524.508938 | 1524.516 | −0.007062489 |
| 4 | 1526.973989 | 1526.98 | −0.006011064 |
| 5 | 1527.229549 | 1527.216 | 0.013549136 |
| 6 | 1528.03365 | 1528.056 | −0.022350308 |
| 7 | 1528.506779 | 1528.5 | 0.006778841 |
| 8 | 1529.77144 | 1529.764 | 0.007440011 |
| 9 | 1530.344737 | 1530.352 | −0.00726343 |
| 10 | 1532.163461 | 1532.156 | 0.007460633 |
| 11 | 1532.767226 | 1532.808 | −0.040773633 |
| 12 | 1539.755617 | 1539.728 | 0.027617164 |
| 13 | 1544.878152 | 1544.86 | 0.018151894 |
| 14 | 1549.336459 | 1549.316 | 0.020458622 |
| 15 | 1553.5831 | 1553.56 | 0.023099804 |
| 16 | 1559.573625 | 1559.532 | 0.04162514 |
| 17 | 1562.889052 | 1562.86 | 0.029052179 |
| 18 | 1563.078723 | 1563.06 | 0.01872279 |
| 19 | 1565.931494 | 1565.896 | 0.035494459 |
| 20 | 1567.082087 | 1567.04 | 0.042086657 |
| 21 | 1569.619122 | 1569.572 | 0.047121507 |
| 22 | 1570.466736 | 1570.396 | 0.070735852 |
| 23 | 1571.238082 | 1571.204 | 0.034082046 |
| 24 | 1573.316937 | 1573.228 | 0.088936685 |
| 25 | 1573.434433 | 1573.364 | 0.070433439 |

TABLE 4.4
Continued with the last table.

| | | λₑₓₚₑᵣᵢₘₑₙₜ | |
|---|---|---|---|
| Channel Number | λ_{target} (nm) | (nm) | λ_{target} − λₑₓₚₑᵣᵢₘₑₙₜ |
| 26 | 1573.928986 | 1573.888 | 0.040986226 |
| 27 | 1576.215317 | 1576.18 | 0.0353169 |
| 28 | 1578.830334 | 1578.816 | 0.014333793 |
| 29 | 1582.048926 | 1582.016 | 0.032925987 |
| 30 | 1584.286887 | 1584.24 | 0.046886847 |
| 31 | 1584.403431 | 1584.368 | 0.035431439 |
| 32 | 1584.553016 | 1584.56 | −0.006983958 |
| 33 | 1588.816606 | 1588.804 | 0.012605702 |
| 34 | 1594.269731 | 1594.24 | 0.029730975 |
| 35 | 1594.365328 | 1594.36 | 0.005328009 |
| 36 | 1596.300787 | 1596.304 | −0.003212903 |
| 37 | 1596.484269 | 1596.508 | −0.023731344 |
| 38 | 1600.981519 | 1600.992 | −0.010481202 |
| 39 | 1601.261073 | 1601.272 | −0.010926527 |
| 40 | 1602.139824 | 1602.16 | −0.020176494 |
| 41 | 1602.668845 | 1602.676 | −0.007155454 |
| 42 | 1604.042243 | 1604.076 | −0.033757417 |
| 43 | 1604.691331 | 1604.724 | −0.032668787 |
| 44 | 1606.66421 | 1606.692 | −0.027789744 |
| 45 | 1607.347481 | 1607.384 | −0.036518508 |
| 46 | 1610.679 | 1610.732 | −0.052999936 |

TABLE 4.5
Major parameters of the fabricated first generation CWBG device.

| Parameter | Value |
|---|---|
| Overall CWBG Length(L) | 2 cm |
| Length of Each Segment in LP/ | 4 μm |
| LA Before Discretization (Δ) | |
| Number of Segments in LP/LA | 5000 |
| Length of Each Discretized Segment (ΔL) | 100 nm |
| Number of Discretized Segments | 200,000 |
| Maximum Effective Index Variation | ±0.014 |
| Si₃N₄ Core Width Range | 400 nm-2 μm |
| Si₃N₄ Core Thickness | 100 nm |
| SiO₂ Cladding Thickness | 5 μm top and 5 μm under |
| Number of Spectral Notches | 46 |
| Suppression Ratios | 10 dB-39 dB |
| 3 dB Bandwidth | 0.3-0.4 nm |
| Spectral Precision | ±0.1 nm |

### 5: Discussion & Further Improvements

### 5.1 Fully-Tunable CWBG

In the previous section, although a powerful CWBG has been experimentally fabricated to remove 20 prescribed spectral dips, there is still a critical problem which remains unanswered: what if those spectral notches are not exactly in their desired locations in the spectrum? How about those dips are all shifted to the left or to the right in the spectrum? This can be a serious problem, as the theoretical index used in the simulation may not be exactly the same as the real index of the CWBG materials. As a very simple example, if we want to design a spectral dip which is centered at 1550.00 nm, in practice the notch may be centered at 1546.55 nm.

To solve this problem, a method which can fully adjust the positions of the spectral notches is found. The basic principle behind this method is this: if the real index of the CWBG is larger than the theoretical index of the CWBG used in the design, then the spectral locations of the real notches will be on the longer-wavelength side of the original desired positions, i.e. they will be red-shifted in practice. So, if we want the real notches to be in the right place, we need to increase the theoretical index correspondingly.

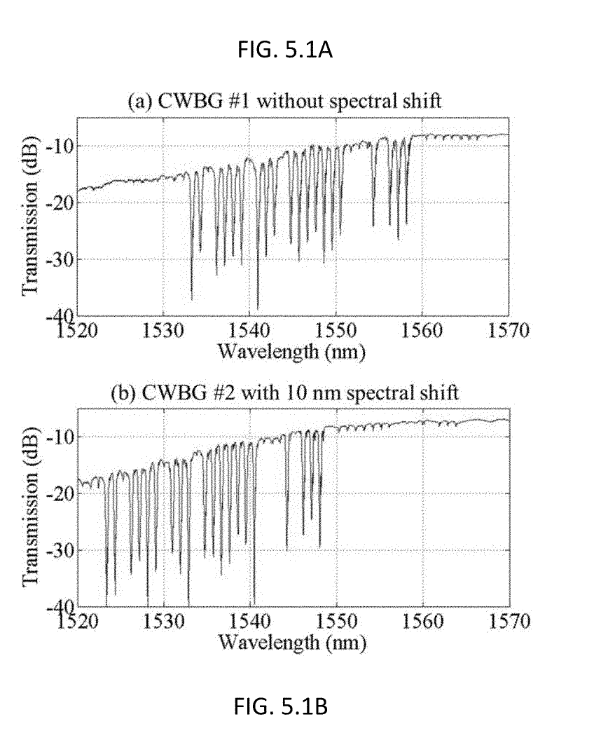

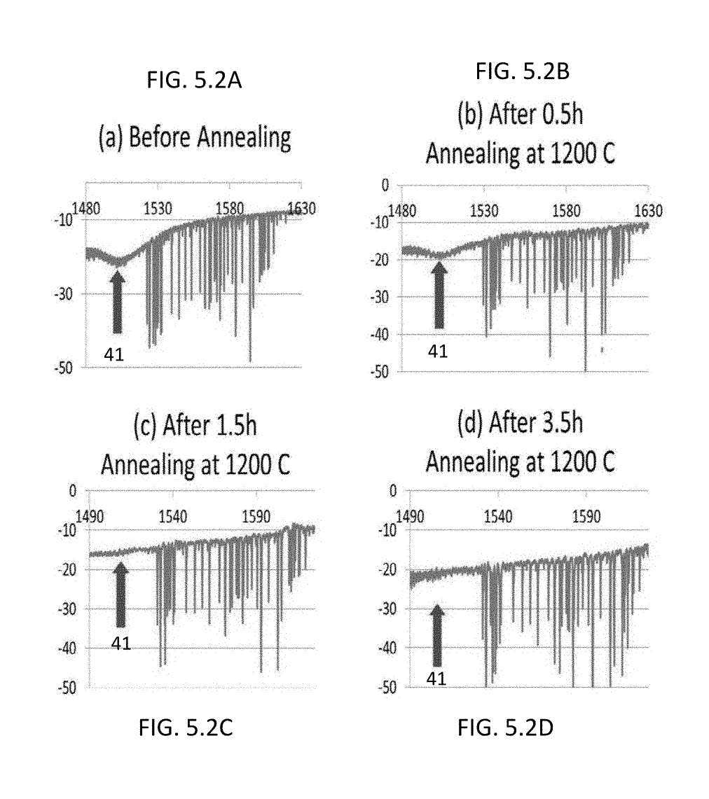

Experimental verification of this idea has been performed, and it proves to be a successful solution. Two CWBGs (CWBG 1 and CWBG 2) are fabricated both with 20 spectral notches. Every parameter is set to be equal for these two CWBGs, but the theoretical index of CWBG1 is set to be 0.01 smaller than the index of CWBG 2. As the theoretical index of CWBG 2 is higher than that of CWBG 1, the notches of CWBG 2 should be shifted 10 nm left with respect to CWBG 1. This theoretical prediction is fully verified by the experimental results, as shown in FIG. 5.1A and FIG. 5.1B.

FIG. 5.1A and FIG. 5.1B demonstrate the possibility of a fully-tunable CWBG. FIG. 5.1A illustrates the originally fabricated CWBG1 whose spectral notches are not shifted. FIG. 5.1B illustrates the second CWBG2 with modified parameters, whose spectral notches are all shifted 10 nm to lower wavelengths.

Therefore, the spectrum of the CWBG can be fully tuned, just by changing a parameter in the algorithm. The fabrication process will always remain the same and straightforward. Using the same principle, separations of the neighboring notches can also be tuned precisely, also simply by adjusting the designed notch position accordingly.

If the spacing between the lines is well-adjusted but, if the whole spectrum is evenly shifted from the desired spectral position, the whole spectrum can be shifted back to the right position by placing the filter chip on a temperature controller. By adjusting the temperature of the TE cooler, the whole spectrum can be shifted by increasing or decreasing the chip temperature.

### 5.2 Annealing

As shown in FIG. 4.10, there is a very obvious absorption dip 41 in the transmission spectrum of our 47-notch grating. This absorption dip is indicated by the arrow 41 in FIG. 5.2A, and it appears clearly at the wavelength of 1500 nm. Several papers [31] [32] have already discussed the reason behind this phenomenon. It is basically associated with H in SiO2 and Si3N4 layers, because hydrogen is one of the major elements in both the PECVD process and the LPCVD process.

To solve this problem of absorption at 1500 nm, a thermal annealing process at the temperature of 1200° C. was performed. The spectrum of the 47-notch grating sample was measured before and after 0.5 hour at 1200° C. in FIG. 5.2B, 1.5 hours at 1200° C. in FIG. 5.2C, and 3.5 hours of annealing process at 1200° C. in FIG. 5.2D, and the experimental results are compared to the initial dip 41 in FIG. 5.2A. It is clear that a 1.5 hour annealing process at 1200° C. as shown in FIG. 5.2C is able to remove the absorption completely.

There is also another absorption dip at around the wavelength of 1.4 μm (not shown), also caused by H in SiO2 and Si3N4 layers. It is contemplated that that absorption dip may be removed using the annealing process.

### 5.3 Some Further Improvement & Future Work

Although the current experimental results are highly advantageous and non-obvious over the prior art, there are still many improvements which can be investigated further or performed in the future.
1. Although a CWBG with 20 dips has been demonstrated, the depths or the suppression ratios of these dips are not exactly the same. Some are deeper at around 25 dB, but some are shallower at around 15-17 dB. In the original design, they are all supposed to have the same suppression ratio. Therefore, more effort is needed to make sure that all spectral notches have the same depths and bandwidths as in the design.
2. As can be seen from all the previous figures of CWBG 150, the side band is not super smooth. In theory it should be a very plain and smooth spectrum without any side-lobes, but in practice there are still some very narrow side-lobes which are around 1 dB deep. There could be caused by insufficient resolution of our current e-beam lithography system in writing very small waveguide width steps (4 nm for the most recent CWBG design). In order to solve this, a more precise e-beam lithography with 100 kV acceleration voltage may be required. The Raith 30 kV e-beam lithography machine being utilized to write the CWBG has a best feature size of around 20-30 nm, assuming the focus, stigma, aperture, etc. are all perfectly adjusted. Ideally, the minimum feature size should be 5 nm or even less. A higher resolution 100 kV EBL system may improve writing the same CWBG patterns.
3. The propagation loss of the CWBG is around 2-3 dB/cm, which is a problem for the application to astrophysics. The overall loss should be minimized as small as possible. Every photon counts importantly in the field of astrophysics. Some of the loss may be from the Si—N bond and N—H bond [32] and [31]. In order to decrease the overall propagation loss or radiation loss of the CWBG, a good way to start here is to perform some thermal annealing process for the fabricated waveguide coupler, for a few hours.
4. For future applications, the CWBG may need to be connected with photonic lanterns, which have 20 or even more output single-mode fibers. The coupling can be a problem. Therefore, it may be useful to try fabricating a waveguide lantern, which can be fabricated on the same chip with CWBG 150 and AWG. Thus everything is integrated on one single chip, eliminating the problem of coupling and connection. Similar waveguide lanterns have been realized in [33] and [34].

### 6: Conclusions

The present disclosure has demonstrated a complex waveguide Bragg grating CWBG 150 both theoretically and experimentally. The CWBG is able to remove multiple randomly-distributed wavelengths in the spectrum. It is fabricated using silica-on-silicon technology with the assistance of e-beam lithography. The whole process is designed to be very straightforward and easy to follow, but it produces one of the most powerful integrated optical filters.

To realize such a CWBG, a LP/LA algorithm is used at first for calculating the grating profile, or the effective index variation along the grating. Then the effective index is converted into a detailed shape/structure of a waveguide grating. The thickness of the waveguide grating is a constant, but the width varies in an aperiodic way. With the help of Matlab script control, about 200,000 small segments are assembled together to form the final shape of CWBG, whose overall length is about 2 cm. After this, a 3D simulation is performed using FIMMWAVE/FIMMPROP, to check if the reconstructed spectrum agrees with the target spectrum or not. If the results are acceptable, the profile of the CWBG is exported from FIMMWAVE/FIMMPROP to a GDSII file for e-beam lithography directly. High coupling fiber-to-waveguide couplers are also added to both sides of the CWBG. Finally, the spectrum of the CWBG is measured with a broadband lightsource, a fiber rotator and an Optical Spectral Analyzer (OSA). Full tunablility of the CWBG is also demonstrated, so the spectral locations of the real dips can appear precisely at their desired positions in the spectrum.

The future improvements will involve realization of 50 and 100 random spectral notches, better accuracy (±0.1 nm) of the spectral position for each notch, and further reduction of the propagation loss. Integration of CWBG with AWG and integrated waveguide lanterns will also be realized.

While several embodiments and methodologies of the present disclosure have been described and shown in the drawings, it is not intended that the present disclosure be limited thereto, as it is intended that the present disclosure be as broad in scope as the art will allow and that the specification be read likewise. Therefore, the above description should not be construed as limiting, but merely as exemplifications of particular embodiments and methodologies. Those skilled in the art will envision other modifications within the scope of the claims appended hereto.

### 11.1 Appendix A

Matlab programs used for Layer Peeling/Adding algorithm are disclosed herein. In this example, the detailed steps on designing a 20-notch filter are shown herein.

### Bibliography

The following documents listed in this Bibliography are incorporated herein by reference in their entirety:
[1] Kenneth O Hill, B Malo, F Bilodeau, D C Johnson, and J Albert. Bragg gratings fabricated in monomode photosensitive optical fiber by uv exposure through a phase mask. Applied Physics Letters, 62(10):1035-1037, 1993.
[2] Andreas Othonos. Fiber bragg gratings. Review of Scientific Instruments, 68(12):4309-4341, 1997.
[3] Raman Kashyap. Fiber bragg gratings. Academic press, 1999.
[4] Andreas Othonos and Kyriacos Kalli. Fiber Bragg gratings: fundamentals and applications in telecommunications and sensing. Artech House, 1999.
[5] Thomas Edward Murphy, Jeffrey Todd Hastings, and Henry I Smith. Fabrication and characterization of narrow-band Bragg-reflection filters in silicon-on-insulator ridge waveguides. Journal of Lightwave Technology, 19(12):1938, 2001.
[6] Graham D Marshall, Martin Ams, and Michael J Withford. Direct laser written waveguide-bragg gratings in bulk fused silica. Optics Letters, 31(18):2690-2691, 2006.
[7] Xu Wang, Wei Shi, Han Yun, Samantha Grist, Nicolas A F Jaeger, and Lukas Chrostowski. Narrow-band waveguide bragg gratings on soi wafers with cmos-compatible fabrication process. Optics Express, 20(14):15547-15558, 2012.
[8] J Bland-Hawthorn, A Buryak, and K Kolossovski. Optimization algorithm for ultrabroadband multichannel aperiodic fiber Bragg grating filters. JOSA A, 25(1):153-158, 2008.
[9] P Rousselot, C Lidman, J-G Cuby, G Moreels, and G Monnet. Night-sky spectral atlas of OH emission lines in the near-infrared. Astronomy and Astrophysics, 354:1134-1150, 2000.
[10] Tiecheng Zhu, Yiwen Hu, Pradip Gatkine, Sylvain Veilleux, Joss Bland-Hawthorn, and Mario Dagenais. Arbitrary on-chip optical filter using complex waveguide bragg gratings. Applied Physics Letters, 108(10):101104, 2016.
[11] Bruno Badoil, Fabien Lemarchand, Michel Cathelinaud, and Michel Lequime. Interest of broadband optical monitoring for thin-film filter manufacturing. Applied Optics, 46(20):4294-4303, 2007.
[12] J Bland-Hawthorn, S C Ellis, S G Leon-Saval, R Haynes, M M Roth, H-G Löhmannsröben, A J Horton, J-G Cuby, Tim A Birks, J S Lawrence, et al. A complex multi-notch astronomical filter to suppress the bright infrared sky. Nature Communications, 2:581, 2011.
[13] S C Ellis, J Bland-Hawthorn, J Lawrence, A J Horton, C Trinh, S G Leon-Saval, K Shortridge, J Bryant, S Case, M Colless, et al. Suppression of the near-infrared OH night-sky lines with fibre Bragg gratings—first results. Monthly Notices of the Royal Astronomical Society, 425(3):1682-1695, 2012.
[14] Christopher Q Trinh, Simon C Ellis, Joss Bland-Hawthorn, Anthony J Horton, Jon S Lawrence, and Sergio G Leon-Saval. The nature of the near-infrared interline sky background using fibre Bragg grating OH suppression. Monthly Notices of the Royal Astronomical Society, 432(4):3262-3277, 2013.
[15] Christopher Q Trinh, Simon C Ellis, Joss Bland-Hawthorn, Jon S Lawrence, Anthony J Horton, Sergio G Leon-Saval, Keith Shortridge, Julia Bryant, Scott Case, Matthew Colless, et al. GNOSIS: the first instrument to use fiber Bragg gratings for OH suppression. The Astronomical Journal, 145(2):51, 2013.
[16] Günter Steinmeyer. A review of ultrafast optics and optoelectronics. Journal of Optics A: Pure and Applied Optics, 5(1):R1, 2003.
[17] Ian W Frank, Yinan Zhang, and Marko Loncar. Nearly arbitrary on-chip optical filters for ultrafast pulse shaping. Optics Express, 22(19):22403-22410, 2014.
[18] Thomas F Krauss. Why do we need slow light? Nature Photonics, 2(8):448-450, 2008.
[19] Johannes Skaar, Ligang Wang, and Turan Erdogan. On the synthesis of fiber bragg gratings by layer peeling. Quantum Electronics, IEEE Journal of, 37(2):165-173, 2001.
[20] Ricardo Feced, Michalis N Zervas, and Miguel A Muriel. An efficient inverse scattering algorithm for the design of nonuniform fiber bragg gratings. Quantum Electronics, IEEE Journal of, 35(8):1105-1115, 1999.
[21] A Buryak, J Bland-Hawthorn, and V Steblina. Comparison of inverse scattering algorithms for designing ultrabroadband fibre bragg gratings. Optics Express, 17(3): 1995-2004, 2009.
[22] Marie Verbist, Dries Van Thourhout, and Wim Bogaerts. Weak gratings in silicon-on-insulator for spectral filters based on volume holography. Optics Letters, 38(3):386-388, 2013.
[23] Marie Verbist, Wim Bogaerts, and Dries Van Thourhout. Design of weak 1-D Bragg grating filters in SOI waveguides using Volume Holography techniques. Journal of Lightwave Technology, 32(10):1915-1920, 2014.
[24] Johannes Skaar. Synthesis and characterization of fiber Bragg gratings. Citeseer, 2000.
[25] Turan Erdogan. Fiber grating spectra. Journal of lightwave technology, 15(8):1277-1294, 1997.
[26] Leon Poladian. Resonance mode expansions and exact solutions for nonuniform gratings. Physical Review E, 54(3):2963, 1996.
[27] Allan W Snyder and John Love. Optical waveguide theory. Springer Science & Business Media, 2012.
[28] Amnon Yariv and Pochi Yeh. Photonics: optical electronics in modern communications (the oxford series in electrical and computer engineering). Oxford University Press, Inc., 2006.
[29] Johannes Skaar and Ole Henrik Waagaard. Design and characterization of finite-length fiber gratings. IEEE Journal of Quantum Electronics, 39(10):1238-1245, 2003.
[30] Geoffrey A Cranch and Gordon M H Flockhart. Tools for synthesising and characterising Bragg grating structures in optical fibres and waveguides. Journal of Modern Optics, 59(6):493-526, 2012.
[31] Charles H Henry, R F Kazarinov, H J Lee, K J Orlowsky, and L E Katz. Low loss Si₃N₄-SiO₂ optical waveguides on Si. Applied Optics, 26(13):2621-2624, 1987.
[32] G Grand, J P Jadot, H Denis, S Valette, A Fournier, and A M Grouillet. Low-loss PECVD silica channel waveguides for optical communications. Electronics Letters, 26(25):2135-2137, 1990.
[33] R R Thomson, Tim A Birks, S G Leon-Saval, A K Kar, and J Bland-Hawthorn. Ultrafast laser inscription of an integrated photonic lantern. Optics Express, 19(6):5698-5705, 2011.
[34] Izabela Spaleniak, Simon Gross, Nemanja Jovanovic, Robert J Williams, Jon S Lawrence, Michael J Ireland, and Michael J Withford. Multiband processing of multimode light: combining 3D photonic lanterns with waveguide Bragg gratings. Laser & Photonics Reviews, 8(1):L1-L5, 2014.
[35] Martijn J R Heck, Jared F Bauters, Michael L Davenport, Daryl T Spencer, and John E Bowers. Ultra-low loss waveguide platform and its integration with silicon photonics. Laser & Photonics Reviews, 8(5):667-686, 2014.
[36] David J Moss, Roberto Morandotti, Alexander L Gaeta, and Michal Lipson. New cmos-compatible platforms based on silicon nitride and hydex for nonlinear optics. Nature Photonics, 7(8):597-607, 2013.
[37] Hongchen Yu, Minghua Chen, Qiang Guo, Marcel Hoekman, Hongwei Chen, Arne Leinse, Rene G Heideman, Richard Mateman, Sigang Yang, and Shizhong Xie. Si 3 n 4-based integrated optical analog signal processor and its application in rf photonic frontend. Photonics Journal, IEEE, 7(5):1-9, 2015.
[38] Leimeng Zhuang, David Marpaung, Maurizio Burla, Willem Beeker, Arne Leinse, and Chris Roeloffzen. Low-loss, high-index-contrast si 3 n 4/sio 2 optical waveguides for optical delay lines in microwave photonics signal processing. Optics Express, 19(23):23162-23170, 2011.
[39] Vittorio M N Passaro, Mario La Notte, Benedetto Troia, Lorenzo Passaquindici, Francesco De Leonardis, and Giovanni Giannoccaro. Photonic structures based on slot waveguides for nanosensors: State of the art and future developments. Int. J. Res. Rev. Appl. Sci, 11(3):402-418, 2012.
[40] Günay Yurtsever, Boris Pova\check{z}ay, Aneesh Alex, Behrooz Zabihian, Wolfgang Drexler, and Roel Baets. Photonic integrated mach-zehnder interferometer with an on-chip reference arm for optical coherence tomography. Biomedical Optics Express, 5(4):1050-1061, 2014.
[41] Jörn P Epping, Tim Hellwig, Marcel Hoekman, Richard Mateman, Arne Leinse, Rene G Heideman, Albert van Rees, Peter J M van der Slot, Chris J Lee, Carsten Fallnich, et al. On-chip visible-to-infrared supercontinuum generation with more than 495 thz spectral bandwidth. Optics Express, 23(15):19596-19604, 2015.
[42] Jared F Bauters, Martijn J R Heck, Demis John, Daoxin Dai, Ming-Chun Tien, Jonathon S Barton, Arne Leinse, Rene G Heideman, Daniel J Blumenthal, and John E Bowers. Ultra-low-loss high-aspect-ratio Si₃N₄ waveguides. Optics Express, 19(4):3163-3174, 2011.
[43] Jared F Bauters, Martijn J R Heck, Demis D John, Jonathon S Barton, Christiaan M Bruinink, Arne Leinse, Rene G Heideman, Daniel J Blumenthal, and John E Bowers. Planar waveguides with less than 0.1 db/m propagation loss fabricated with wafer bonding. Optics Express, 19(24):24090-24101, 2011.
[44] Christopher R Doerr, Long Chen, Young-Kai Chen, and Larry L Buhl. Wide bandwidth silicon nitride grating coupler. IEEE Photonics Technology Letters, 22(19):1461-1463, 2010.
[45] A Z Subramanian, Pieter Neutens, Ashim Dhakal, Roelof Jansen, Tom Claes, Xavier Rottenberg, Frederic Peyskens, Shankar Selvaraja, Philippe Helin, Bert Dubois, et al. Low-loss singlemode PECVD silicon nitride photonic wire waveguides for 532-900 nm wavelength window fabricated within a CMOS pilot line. Photonics Journal, IEEE, 5(6):2202809-2202809, 2013.
[46] Huijuan Zhang, Chao Li, Xiaoguang Tu, Junfeng Song, Haifeng Zhou, Xianshu Luo, Ying Huang, Mingbin Yu, and G Q Lo. Efficient silicon nitride grating coupler with distributed Bragg reflectors. Optics Express, 22(18):21800-21805, 2014.
[47] Wesley D Sacher, Ying Huang, Liang Ding, Benjamin J F Taylor, Hasitha Jayatilleka, Guo-Qiang Lo, and Joyce K S Poon. Wide bandwidth and high coupling efficiency Si₃N₄-on-SOI dual-level grating coupler. Optics Express, 22(9):10938-10947, 2014.
[48] Wissem Sfar Zaoui, Andreas Kunze, Wolfgang Vogel, Manfred Berroth, Jörg Butschke, Florian Letzkus, and Joachim Burghartz. Bridging the gap between optical fibers and silicon photonic integrated circuits. Optics Express, 22(2):1277-1286, 2014.
[49] S H Tao, Junfeng Song, Qing Fang, Mingbin Yu, Guoqiang Lo, and Dimlee Kwong. Improving coupling efficiency of fiber-waveguide coupling with a double-tip coupler. Optics Express, 16(25):20803-20808, 2008.
[50] T G Tiecke, K P Nayak, J D Thompson, T Peyronel, N P de Leon, V Vuletić, and M D Lukin. Efficient fiber-optical interface for nanophotonic devices. Optica, 2(2):70-75, 2015.
[51] FIMMWAVE/FIMMPROP by Photon Design Ltd., http://www.photond.com.
[52] Application note nuapp-3: Uhna fiber efficient coupling to siliconwaveguides. Nufern Inc http://www.nufern.com/pam/optical_fibers/984/UHNA3/.
[53] T Shoji, T Tsuchizawa, T Watanabe, K Yamada, and H Morita. Low loss mode size converter from 0.3 μm square si wire waveguides to singlemode fibres. Electronics Letters, 38(25):1669-1670, 2002.
[54] Jaime Cardenas, Carl B Poitras, Kevin Luke, Lian-Wee Luo, Paul Adrian Morton, and Michal Lipson. High coupling efficiency etched facet tapers in silicon waveguides. IEEE Photonics Technol. Lett, 26(23):2380-2382, 2014.
[55] Victor Nguyen, Trisha Montalbo, Christina Manolatou, Anu Agarwal, Chingyin Hong, John Yasaitis, L C Kimerling, and Jurgen Michel. Silicon-based highly-efficient fiber-to-waveguide coupler for high index contrast systems. Applied Physics Letters, 88(8):081112, 2006.
[56] Long Chen, Christopher R Doerr, Young-Kai Chen, and Tsung-Yang Liow. Low-Loss and Broadband Cantilever Couplers Between Standard Cleaved Fibers and High-Index-Contrast Si N or Si Waveguides. Photonics Technology Letters, IEEE, 22(23):1744-1746, 2010.
[57] F Ay and A Aydinli. Comparative investigation of hydrogen bonding in silicon based PECVD grown dielectrics for optical waveguides. Optical Materials, 26(1):33-46, 2004.
[58] Daoxin Dai, Zhi Wang, Jared F Bauters, M-C Tien, Martijn J R Heck, Daniel J Blumenthal, and John E Bowers. Low-loss Si₃N₄ arrayed-waveguide grating (de) multiplexer using nano-core optical waveguides. Optics Express, 19(15):14130-14136, 2011.
[59] Pradip Gatkine, Sylvain Veilleux, Yiwen Hu, Tiecheng Zhu, Yang Meng, Joss Bland-Hawthorn, and Mario Dagenais. Development of high-resolution arrayed waveguide grating spectrometers for astronomical applications: first results, 2016.

Publications

The following documents in this listing of Publications are incorporated herein by reference in their entirety:

Journal Papers
Tiecheng Zhu, Yiwen Hu, Pradip Gatkine, Sylvain Veilleux, Joss Bland-Hawthorn, and Mario Dagenais. “Arbitrary on-chip optical filter using complex waveguide Bragg gratings.” Applied Physics Letters 108, no. 10 (2016): 101104.
Tiecheng Zhu, Yi-Wen Hu, Pradip Gatkine, Sylvain Veilleux, Joss Bland-Hawthorn, and Mario Dagenais. “Ultra-broadband High Coupling Efficiency Fiber-to-Waveguide Coupler Using Si3N4/SiO2 Waveguides On Silicon.” IEEE Photonics Journal, vol. 8, no. 5, pp. 1-12, October 2016.
Pradip Gatkine, Sylvain Veilleux, Yiwen Hu, Tiecheng Zhu, Yang Meng, Joss Bland-Hawthorn, and Mario Dagenais. “Development of high resolution arrayed waveguide grating spectrometers for astronomical applications: first results.” arXiv preprint arXiv:1606.02730 (2016).

Conference Papers
(Invited) Tiecheng Zhu, Sylvain Veilleux, and Mario Dagenais, “Si3N4/SiO2 on Si Nanophotonics for Arbitrary Optical Filters and High Efficiency Couplers.” Optical Society of America (OSA) Photonics North, 2016
Tiecheng Zhu, Sylvain Veilleux, Joss Bland-Hawthorn, and Mario Dagenais. “Ultra-broadband High Coupling Efficiency Using a Si 3 N 4/SiO2 waveguide on silicon.” Photonics Society Summer Topical Meeting Series (SUM), 2016 IEEE, pp. 92-93. IEEE, 2016.
Tiecheng Zhu, Sylvain Veilleux, Joss Bland-Hawthorn, and Mario Dagenais. “Complex Waveguide Bragg Gratings For arbitrary spectral filtering.” Photonics Society Summer Topical Meeting Series (SUM), 2016 IEEE, pp. 211-212. IEEE, 2016.
(Invited) Tiecheng Zhu, Sylvain Veilleux, Joss Bland-Hawthorn, and Mario Dagenais. “Ultra high coupling efficiency from a single mode fiber to a high index contrast on-chip waveguide and complex waveguide Bragg gratings for spectral filtering.” 2015 IEEE Summer Topicals Meeting Series (SUM), pp. 19-20. IEEE, 2015.

What is claimed is:

1. A waveguide Bragg grating comprising:
a silicon substrate defining a length, a width and a depth; and
a silicon dioxide (SiO₂) cladding over the silicon substrate and encasing
a silicon nitride (Si₃Ni₄) core extending along the length of the silicon substrate and defining a variable width and thickness;
wherein the silicon nitride (Si₃Ni₄) core is configured as and functions as a complex Bragg grating waveguide.

2. The waveguide Bragg grating according to claim 1, wherein the thickness of the silicon nitride (Si₃Ni₄) core ranges from 40-400 nm.

3. The waveguide Bragg grating according to claim 2, wherein the thickness of the silicon nitride (Si₃Ni₄) core is 100 microns (μm).

4. The waveguide Bragg grating according to claim 1, wherein the waveguide Bragg grating is designed by:
determining a grating profile of the silicon nitride (Si₃Ni₄) core from a Layer Peeling algorithm and a Layer Adding algorithm; and
mapping the grating profile to a 1-layer waveguide structure with varying width dimensions.

5. The waveguide Bragg grating according to claim 4, wherein the waveguide Bragg grating is further designed by:
relating the grating profile to an effective index variation defining a range along the grating and
mapping the range of the effective index variation to the 1-layer waveguide structure with varying width dimensions,
such that a single specific waveguide width corresponds to a single specific effective index,
thereby converting output of the Layer Peeling algorithm and the Layer Addition algorithm to an aperiodic array of widths for the complex waveguide.

6. The waveguide Bragg grating according to claim 5, wherein the waveguide Bragg grating is designed by:
discretizing the waveguide grating into individual rectangular segments each defining a fixed width and a variable length such that the number of waveguide segments equals to a number of segments in the aperiodic array of widths for the complex waveguide.

7. The waveguide Bragg grating according to claim 6, wherein the waveguide Bragg grating is further prepared for electron beam lithography via simulating the aperiodic array of widths via finite difference method (FDM) and eigen mode expansion (EME).

8. The waveguide Bragg grating according to claim 7, wherein the simulating the aperiodic array of widths via finite difference method (FDM) and eigen mode expansion (EME) includes simulating a three-dimensional array of widths via finite difference method (FDM) and eigen mode expansion (EME).

9. A method of designing a waveguide Bragg grating by:
determining a grating profile of the silicon nitride (Si₃Ni₄) core from a Layer Peeling algorithm and a Layer Adding algorithm; and
mapping the grating profile to a 1-layer waveguide structure with varying width dimensions.

10. The method of designing a waveguide Bragg grating according to claim 9, wherein the waveguide Bragg grating is further formed by:
relating the grating profile to an effective index variation defining a range along the grating and
mapping the range of the effective index variation to the 1-layer waveguide structure with varying width dimensions,
such that a single specific waveguide width corresponds to a single specific effective index,
thereby converting output of the Layer Peeling algorithm and the Layer Addition algorithm to an aperiodic array of widths for the complex waveguide.

11. The method of designing a waveguide Bragg grating according to claim 10, wherein the waveguide Bragg grating is formed by:
discretizing the waveguide grating into individual rectangular segments each defining a fixed width and a variable length such that the number of waveguide segments equals to a number of segments in the aperiodic array of widths for the complex waveguide.

12. The method of designing a waveguide Bragg grating according to claim 11, wherein the waveguide Bragg grating is further prepared for electron beam lithography via simulating the aperiodic array of widths via finite difference method (FDM) and eigen mode expansion (EME).

13. The method of designing a waveguide Bragg grating according to claim 12, wherein the simulating the aperiodic array of widths via finite difference method (FDM) and eigen mode expansion (EME) includes simulating a three-dimensional array of widths via finite difference method (FDM) and eigen mode expansion (EME).

14. A method of manufacturing a waveguide Bragg grating comprising:
providing a silicon wafer thermal SiO2 layer grown on a first surface of the silicon wafer;
depositing via using low-pressure chemical vapor deposition (LPCVD) a Si3N4 layer on the thermal SiO2 layer;
patterning a profile of the waveguide Bragg grating via electron beam lithography;
providing a hard mask on the Si3N4 layer;
performing reactive ion etching of the Si3N4 layer where it is not protected by a mask and removing the hard mask;
depositing a low-stress SiO2 layer on top of the wafer via one of a silane based plasma-enhanced chemical vapor deposition of SiO2 or a low-stress tetraethoxysilane (TEOS) plasma-enhanced chemical vapor deposition (PECVD) process; and
cleaving end-facets to form thereby a complex waveguide Bragg grating.

15. The method of manufacturing according to claim 14, further including polishing a second surface of the silicon wafer wherein the second surface is on an opposing side of the first surface of the silicon wafer prior to cleaving the nd-facets to form thereby a complex waveguide Bragg grating.

16. The method of manufacturing according to claim 14, wherein the patterning of a profile of the waveguide Bragg grating via electron beam lithography includes
controlling writefield alignment of the profile; and
overlapping neighboring writefields with each other to control stitching error.

17. The method of manufacturing according to claim 14, wherein the providing a silicon wafer with a thermal SiO2 layer grown on a first surface of the silicon wafer includes providing a silicon wafer with a 3-15 μm thermal SiO2 layer grown on a first surface of the silicon wafer.

18. The method of manufacturing according to claim 17, wherein the depositing via using low-pressure chemical vapor deposition (LPCVD) a Si3N4 layer on the thermal SiO2 layer includes depositing via using low-pressure chemical vapor deposition (LPCVD) a 100 nm thick Si3N4 layer on the 3-15 μm thermal SiO2 layer.

19. The method of manufacturing according to claim 14 wherein the providing a hard mask on the Si3N4 layer,
performing reactive ion etching of the Si3N4 layer and
removing the hard mask are performed by
providing a chromium hard mask on the Si3N4 layer,
performing reactive ion etching of the Si3N4 layer and
removing the chromium hard mask.

20. The method of manufacturing according to claim 14,
wherein the depositing a low-stress SiO2 layer on top of the wafer via one of a silane based plasma-enhanced chemical vapor deposition of SiO2 or a low-stress tetraethoxysilane (TEOS) plasma-enhanced chemical vapor deposition (PECVD) process includes
depositing a 3-15 μm low-stress SiO2 layer on top of the wafer via one of a silane based plasma-enhanced chemical vapor deposition of SiO2 or a low-stress tetraethoxysilane (TEOS) plasma-enhanced chemical vapor deposition (PECVD) process.
